(19) United States
(12) Patent Application Publication
(10) Pub. No.: US 2018/0082672 A1
(43) Pub. Date: Mar. 22, 2018

(54) INFORMATION PROCESSING APPARATUS AND INFORMATION PROCESSING METHOD THEREOF

(71) Applicant: Sony Corporation, Tokyo (JP)

(72) Inventors: Yasunobu Murata, Tokyo (JP); Kohei Asada, Kanagawa (JP); Mitsuhiro Suzuki, Tokyo (JP); Tetsunori Itabashi, Kanagawa (JP); Go Igarashi, Tokyo (JP)

(73) Assignee: Sony Corporation, Tokyo (JP)

(21) Appl. No.: 15/560,149

(22) PCT Filed: Mar. 11, 2016
(86) PCT No.: PCT/JP2016/057738

§ 371 Date: Sep. 20, 2017

(30) Foreign Application Priority Data
Mar. 27, 2015 (JP) 2015-067131

(51) Int. Cl. G10K 11/175

(52) U.S. Cl. CPC G10K 11/175; H04R 2460/01

(57) ABSTRACT

The present technology relates to an information processing apparatus and an information processing method thereof that allow the realization of predetermined functions in information processing apparatuses of many types. An information processing system has a first information processing apparatus and a second information processing apparatus. The first information processing apparatus has a parameter supply block configured to supply an intermediate parameter having a format common to two or more second information processing apparatuses, the intermediate parameter being a parameter unique to the first information processing apparatus. The second information processing apparatus has a generation block configured to generate an adjustment parameter suitable for the second information processing apparatus from an intermediate parameter received from the first information processing apparatus and a signal computation block configured to compute a signal on the basis of the adjustment parameter generated by the generation block.

### TECHNICAL FIELD

The present technology relates to an information processing apparatus and an information processing method thereof, more particularly, to an information processing apparatus and an information processing method thereof that are configured to realize predetermined functions on multitude types of information processing apparatuses.

### BACKGROUND ART

When a user uses a headphone outdoors, the noise existing around may be superposed on a source sound such as music originally supposed to be listened by the user as a noise, thereby making it difficult for the user to listen to the source sound. In order to solve this problem, technologies of noise canceling have been proposed (for example, PTL 1).

Now, referring to FIG. 1, there is depicted a diagram illustrating a configuration of a related-art noise canceling system. A noise canceling system 1 is configured by a host terminal 11 made up of a smartphone and a headphone 12 that is an accessory device connected thereto. It should be noted that the headphone 12 is a headphone having noise canceling functions, so that this headphone is indicated as an NC headphone in FIG. 1.

The host terminal 11 has a multiplexed data interface 21 and a noise canceling core (NC core) 22. The headphone 12 has a nonvolatile memory 31 and a multiplexed data interface 32. When a plug 33 of the headphone 12 is connected to the host terminal 11, the host terminal 11 and the headphone 12 are ready to execute multiplexed data communication through each the multiplexed data interface 21 and the multiplexed data interface 32. Using this multiplexed data communication, noise cancelation processing is executed.

The nonvolatile memory 31 stores, as native parameters, such parameters unique to each accessory device as necessary for noise cancelation processing, in addition to produce information including product identification (ID) and product model name. Upon reception of the supply of the native parameters from the headphone 12, the noise canceling core 22 of the host terminal 11 uses the received native parameters to execute noise cancelation processing. That is, a signal for canceling noise is added to a music signal, for example as a source sound supplied from the host terminal 11 to the headphone 12. As a result, a user using the headphone 12 can listen to the music with noise suppressed.

### CITATION LIST

### Patent Literature

[PTL 1]

Japanese Patent No. 4882773

### SUMMARY

### Technical Problems

The noise canceling core 22 is configured by hardware in many cases. The noise canceling core 22 has a filter for noise cancelation, the configuration, filter coefficient, data bit length, and accuracy thereof or the like are dependent upon products. In addition, the noise canceling core 22 may have functions uniquely developed by the maker thereof, so specifications that are different from product to product. Further, noise cancelation processing is also affected by the characteristics of peripheral circuits to the host terminal 11.

Therefore, in order to generate native parameters to be held in the headphone 12, it is necessary to know not only the configuration of the headphone 12 but also the configurations, functions and so on of the host terminal 11 and the noise canceling core 22. However, generally, it is very difficult to know all these items of information by makers of the headphone 12.

In an example depicted in FIG. 1, for example, the headphone 12 is made by company A, the host terminal 11 is made by company S, and the noise canceling core 22 built in the host terminal 11 as a part is made by company Y. In order to realize a noise canceling function in the headphone 12, it is necessary for maker A thereof must know beforehand the configurations and functions of the noise canceling core 22 of company Y and the peripheral circuits of the host terminal 11 of company S.

Further, it is desirable for the headphone 12 to realize the noise canceling functions not only with the host terminal 11 of company S but also with the host terminal 11 of another maker. Obviously, this holds with other models of the host terminal 11 of company S. In order to realize the noise canceling functions of the headphone 12 with all types of the host terminal 11, it is necessary to store in the nonvolatile memory 31 the native parameters corresponding to the host terminal 11 and the noise canceling core 22 of all types. It is very difficult to store the native parameters corresponding to the host terminal 11 and the noise canceling core 22 of all types into the nonvolatile memory 31. Also, a new host terminal 11 or a new noise canceling core 22 may be manufactured after the manufacture of the headphone 12.

It has been practical measures to store in the nonvolatile memory 31 the native parameters related with the typical, limited types of host terminals 11 and noise canceling cores 22 from which a predetermined host terminal 11 and a predetermined noise canceling core 22 are selected. Specifically, it has been difficult to realize noise canceling functions on many types of host terminals 11.

Therefore, the present technology addresses the above-described problem and realizes predetermined functions on many more types of information processing apparatuses.

### Solution to Problems

In carrying out the present technology and according to one aspect thereof, there is provided an information processing apparatus. This information processing apparatus includes a generation block configured, upon receiving an intermediate parameter having a format common to a plurality of information processing apparatuses, the intermediate parameter being a parameter unique to a predetermined device from the device, to generate an adjustment parameter suitable for an own information processing apparatus from the intermediate parameter and a signal computation block configured to compute a signal on the basis of the adjustment parameter generated by the generation block.

The information processing apparatus may be a host terminal connected to an accessory device that is the device.

The intermediate parameter can include a parameter related with a transfer function of a signal computation block that computes a signal on the basis of the adjustment parameter of the information processing apparatus and a parameter related with a physical characteristic of the accessory device.

The information processing apparatus can receive one of the intermediate parameter held in the device and the intermediate parameter on the basis of information necessary for accessing the intermediate parameter.

The information processing apparatus can further receive an environment signal indicative of an environment state computed on the basis of the adjustment parameter.

The information processing apparatus can receive the environment signal that mitigates an influence of the environment state on the basis of the adjustment parameter.

The accessory device can execute multiplexed data communication with the host terminal through a multi-pole plug.

In carrying out the present technology and according to another aspect thereof, there is provided an information processing method for an information processing apparatus. This information processing method includes generating, upon receiving an intermediate parameter having a format common to a plurality of information processing apparatuses, the intermediate parameter being a parameter unique to a predetermined device from the predetermined device, an adjustment parameter suitable for the own information processing apparatus from the intermediate parameter and computing a signal on the basis of the generated adjustment parameter.

In carrying out the present technology and according to still another aspect thereof, there is provided an information processing apparatus. This information processing apparatus includes a parameter supply block configured to supply an intermediate parameter having a format common to a plurality of devices to the device, the intermediate parameter being unique to an own information processing apparatus and a reception block configured to receive, from the device, a computation signal computed on the basis of adjustment parameter suitable for the device generated from the intermediate parameter in the device.

The information processing apparatus may be an accessory device connected to a host terminal that is the device.

The intermediate parameter can include a parameter related with a transfer function of a signal computation block that computes a signal on the basis of the adjustment parameter of the device and a parameter related with a physical characteristic of the accessory device.

The parameter supply block can supply one of the intermediate parameter held therein and information necessary for accessing the intermediate parameter.

The information processing apparatus can further include an environment signal supply block configured to supply, to the device, an environment signal indicative of an environment state computed on the basis of the adjustment parameter.

The environment supply block can supply the environment signal that mitigates an influence of the environment state on the basis of the adjustment parameter.

The accessory device can execute multiplexed data communication with the host terminal through a multi-pole plug.

In carrying out the present technology and according to yet another aspect thereof, there is provided an information processing method for an information processing apparatus. This information processing method includes supplying an intermediate parameter having a format common to a plurality of devices to the device, the intermediate parameter being unique to an own information processing apparatus and receiving, from the device, a computation signal computed on the basis of adjustment parameter suitable for the device generated from the intermediate parameter in the device.

In one aspect of the present technology, if an intermediate parameter having a format common to two or more information processing apparatuses, the intermediate parameter being a parameter unique to a predetermined device, is received from the device, an adjustment parameter suitable for the own information processing apparatus is generated from the intermediate parameter and a signal is computed on the basis of the generated adjustment parameter.

In another aspect of the present technology, an intermediate parameter having a format common to two or more devices is supplied to the device, the intermediate parameter being a parameter unique to the own information processing apparatus and a computation signal computed on the basis of an adjustment parameter suitable for the device generated from the intermediate parameter in the device is received from the device.

### Advantageous Effects of Invention

As described above, according to one aspect of the present technology, predetermined functions can be realized on many types of information processing apparatuses.

It should be noted that the advantageous effects of the present technology described herein are illustrative only and therefore are not limited thereto, variations may be added to the above-mentioned advantageous effects.

### BRIEF DESCRIPTION OF DRAWINGS

FIG. 1 is a diagram illustrating a configuration of a related-art noise canceling system.

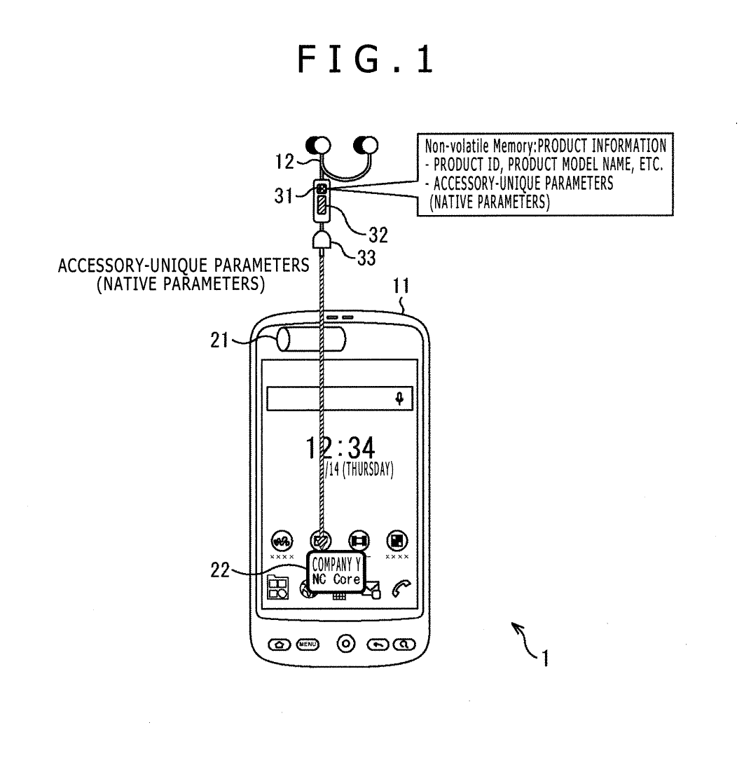

FIG. 2 is a circuit diagram illustrating the principles of operation of a noise canceling function of the present technology.

FIG. 3 is a block diagram illustrating a basic configuration of the present technology.

FIG. 4 is a diagram illustrating a state of use of one embodiment of a system of the present technology.

FIG. 5 is a diagram illustrating another state of use of one embodiment of the system of the present technology.

FIG. 6 is a diagram illustrating still another state of use of one embodiment of the system of the present technology.

FIG. 7 is a diagram illustrating a basic operation of a translator.

FIG. 8 is a block diagram illustrating a more detail configuration of a state of use of one embodiment of the system of the present technology.

FIG. 9 is a diagram describing a format of intermediate parameters.

FIG. 10 is a diagram illustrating basic operations of a host terminal and a headphone.

FIG. 11 is a block diagram illustrating a configuration of an NC filter.

FIG. 12 is a diagram illustrating an example of intermediate parameters.

FIG. 13 is a diagram illustrating an example of description of intermediate parameters.

FIG. 14 is a flowchart indicative of processing of a universal noise canceling (UNC) mode.

FIG. 15 is a flowchart indicative of an operation of a headphone.

FIG. 16 is a flowchart indicative of mode selection processing.

FIG. 17 is a flowchart indicative of mode selection processing.

FIG. 18 is a flowchart indicative of mode selection processing.

FIG. 19 is a block diagram illustrating an example of a configuration of hardware of a computer.

### DESCRIPTION OF EMBODIMENTS

The following describes modes of practicing the present technology (hereafter referred to as embodiments). The description is made in the following order.

1. Principles of operation of cancelation processing

2. Basic configuration of the present technology

3. States of use of one embodiment of a system of the present technology

4. Basic operation of a translator

5. Configuration of one embodiment of the system of the present technology

6. Operation of one embodiment of the system of the present technology

7. Processing of a headphone

8. Processing of mode selection

9. Variations

10. Others

<1. Principles of Operation of Cancelation Processing>

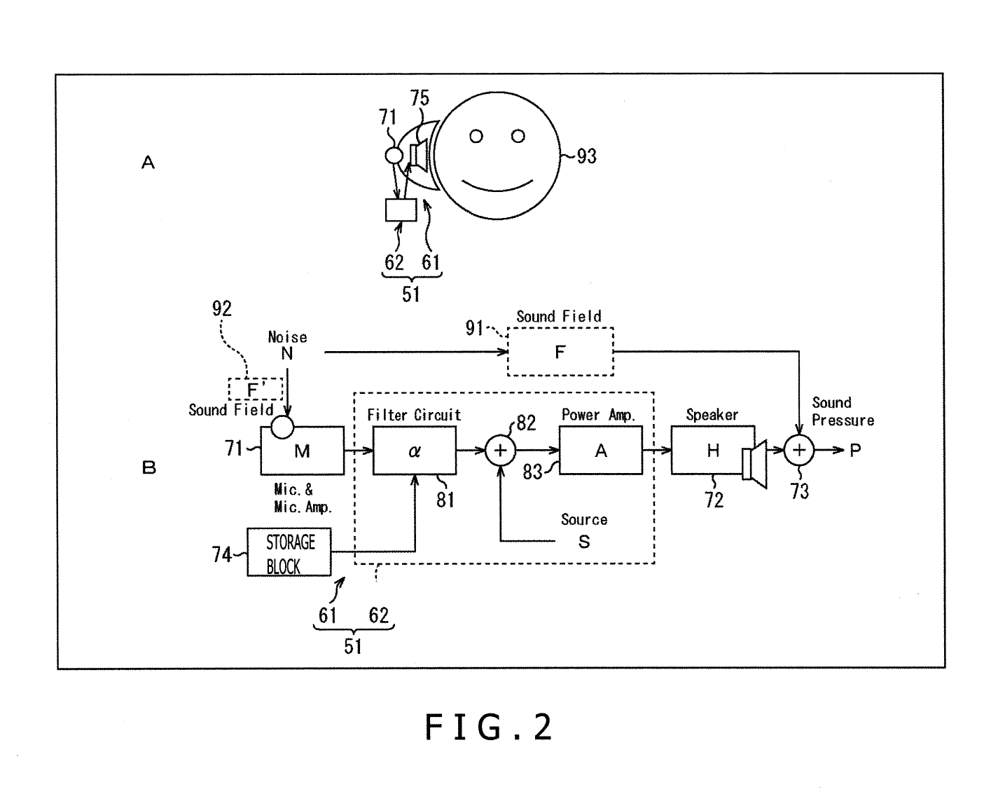

Now, referring to FIG. 2, there is depicted a circuit diagram illustrating the principles of operation of noise canceling function of the present technology. As depicted in FIG. 2, an information processing apparatus 51 is configured by a headphone 61 that is an accessory device as one information processing apparatus and a host terminal 62 that is the other information processing apparatus. In this embodiment, the host terminal 62 is configured by a smartphone.

The headphone 61 is configured by a microphone 71 (including a microphone amplifier), a speaker (or a driver) 72, an adder 73, and a storage block 74. The headphone 61 worn on the ear of a user 93 and the microphone 71 picks up a surrounding noise and transforms the picked up noise into an electrical signal which is outputted. That is, a signal corresponding to a state of the surrounding environment is outputted. The speaker 72 outputs a sound corresponding to the entered electrical signal. The adder 73 is actually configured by the ear of the user 93 and a space of the headphone 61 that covers the ear. Specifically, the adder 73 synthesizes a noise that is a noise component generated by a predetermined noise source with a sound outputted from the speaker 72. The resultant synthesized sound is heard by the user as an actual audio. The storage block 74 stores intermediate parameters. Details of intermediate parameters will be described later.

The host terminal 62 has a filter 81, an adder 82, and a power amplifier 83. The filter 81 generates native parameters from intermediate parameters stored in the storage block 74. The native parameters include a filter coefficient which is set to the filter 81. The adder 82 adds a noise canceling signal outputted by the filter 81 to a signal such as music that is listened by the user 93. The power amplifier 83 amplifies the output signal from the adder 82 with a predetermined gain specified by a native parameter and outputs the amplified signal to the speaker 72.

To be more specific, a microphone signal of the noise picked up by the microphone 71 provides a noise canceling signal that is a signal obtained by computing a native parameter by the preset filter 81. This noise canceling signal as an environmental signal is supplied to the power amplifier 83 through the adder 82 to be amplified, a resultant amplified signal being outputted from the speaker 72. Also, the source signal such as music is supplied to the power amplifier 83 through the adder 82 to be amplified, a resultant amplified signal being outputted from the speaker 72. That is, a sound corresponding to a signal obtained by adding a noise canceling signal to a source signal is supplied to the space of the ear of the user. Then, these sounds are added by the adder 73 formed in the space of the ear of the user, thereby causing the eardrum in the ear of the user to vibrate.

Let an output of the adder 73 be P, a source signal such as music be S, and a noise be N and transfer functions of the microphone 71, the filter 81, the power amplifier 83, and the speaker 72 be M, α, A, and H, respectively. In addition, let transfer functions of an audio space from the noise source to the adder 73 and an audio space from the noise source to the microphone 71 be F and F′, respectively. Then, the following expression is established.

P=F′AHMαN+FN+AHS (1)

Further, by adjusting the filter coefficient of the filter 81 to a predetermined value, the following expression is established.

F≈−(F′AHMα) (2)

Consequently, expression (1) can be expressed by the following expression:

P≈AHS (3)

That is, noise canceling computation is executed such that the noise canceling signal cancels at the position of the eardrum.

<2. Basic Configuration of the Present Technology>

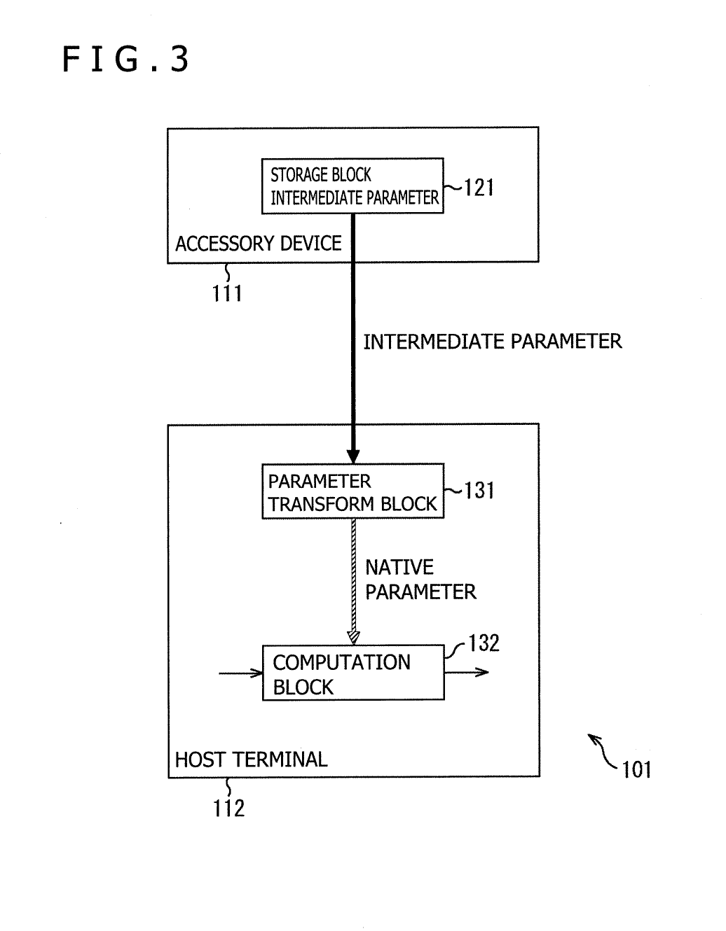

Referring to FIG. 3, there is depicted a block diagram illustrating the basic configuration of the present technology. As depicted in FIG. 3, an information processing system 101 based on the present technology is configured by an accessory device 111 and a host terminal 112 connected thereto in a wired or a wireless manner.

The accessory device 111 has a storage block 121 configured by a nonvolatile memory, for example. The storage block 121 stores an intermediate parameter of the accessory device 111.

The intermediate parameter is a parameter unique to the accessory device 111 and is used for noise cancelation processing of a format common to two or more host terminals 112. That is, this parameter does not depend on the specifications of the noise canceling core and the host terminal. This parameter may be said to be intermediate parameter in the sense that this parameter is eventually transformed into a more detail native parameter. The intermediate parameter may be said to be a common parameter in the sense that the intermediate parameter has a format common to two or more host terminals 112. Conversely, the native parameter is a parameter adjusted only for the format matching the specifications of a particular host terminal 112 and the noise canceling core thereof, so that the native parameter may be said to be an adjusted parameter.

An intermediate parameter may be directly stored in the storage block 121, however, it is also practicable for the storage block 121 to store information necessary for accessing an intermediate parameter such as uniform resource locator (URL), for example, thereby providing the intermediate parameter therefrom.

The host terminal 112 has a parameter transform block 131 and a computation block 132. The parameter transform block 131 transforms an intermediate parameter supplied from the storage block 121 of the accessory device 111 into a native parameter. In other words, a native parameter is generated. The computation block 132 executes a computation necessary for noise cancelation processing on the basis of the native parameter supplied from the parameter transform block 131.

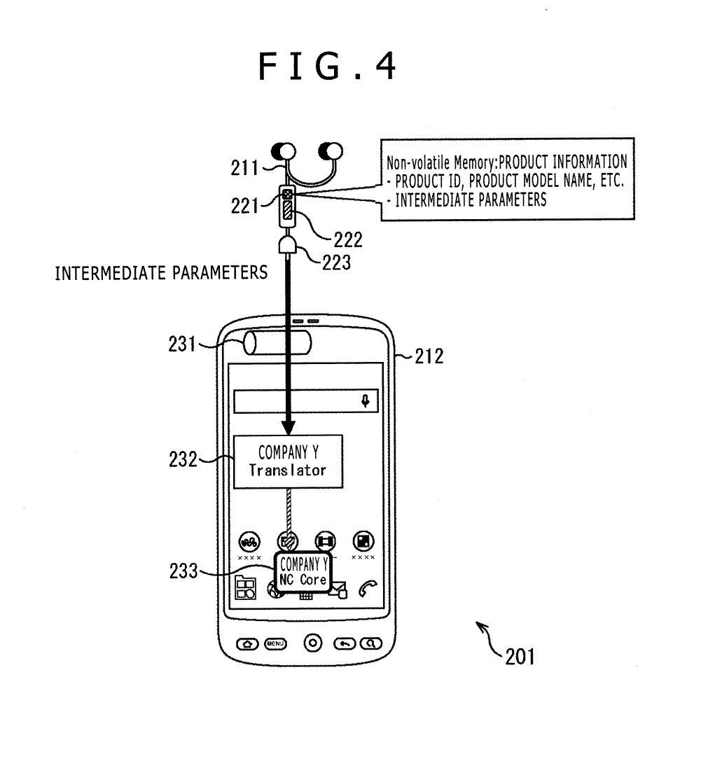

An intermediate parameter is a parameter for noise cancelation processing of a format common to two or more host terminals 112. By contrast, a native parameter is a parameter suitable for the characteristics of a noise cancelation processing block (noise canceling core 233 depicted in FIG. 4 to be described later, for example) incorporated in the host terminal 112 and peripheral circuit blocks thereto, thereby providing a parameter of a format unique to the host terminal 112.

The format of an intermediate parameter is made common to two or more makers of accessory devices 111 and host terminals 112 upon consultation for standardization. The standard on the side of the accessory device 111 specifies the parameter content and driver sensitivity that are necessary to be described as an intermediate parameter having defined content. The standard on the side of the host terminal 112 specifies the installation of the parameter transform block (or the translator) 131 and the installation of a noise canceling core for computing the noise cancelation filtering characteristics from an intermediate parameter.

The maker of the accessory device 111 may only describe a parameter (namely, an intermediate parameter) for executing noise cancelation processing in accordance with the format of the accessory device. A native parameter that depends upon the configuration and specifications of the host terminal 112 and the noise cancelation processing block thereof is generated by the maker of the host terminal 112, to be more specific, by the parameter transform block 131. As a result, the accessory device 111 can realize the noise canceling function between all host terminals 112 that satisfy the standards.

This information processing system 101 is configured by two separate apparatuses. Since the accessory device 111 can be powered from the host terminal 112, no battery is required, resulting in the reduction in manufacturing cost.

<3. States of Use of One Embodiment of a System of the Present Technology>

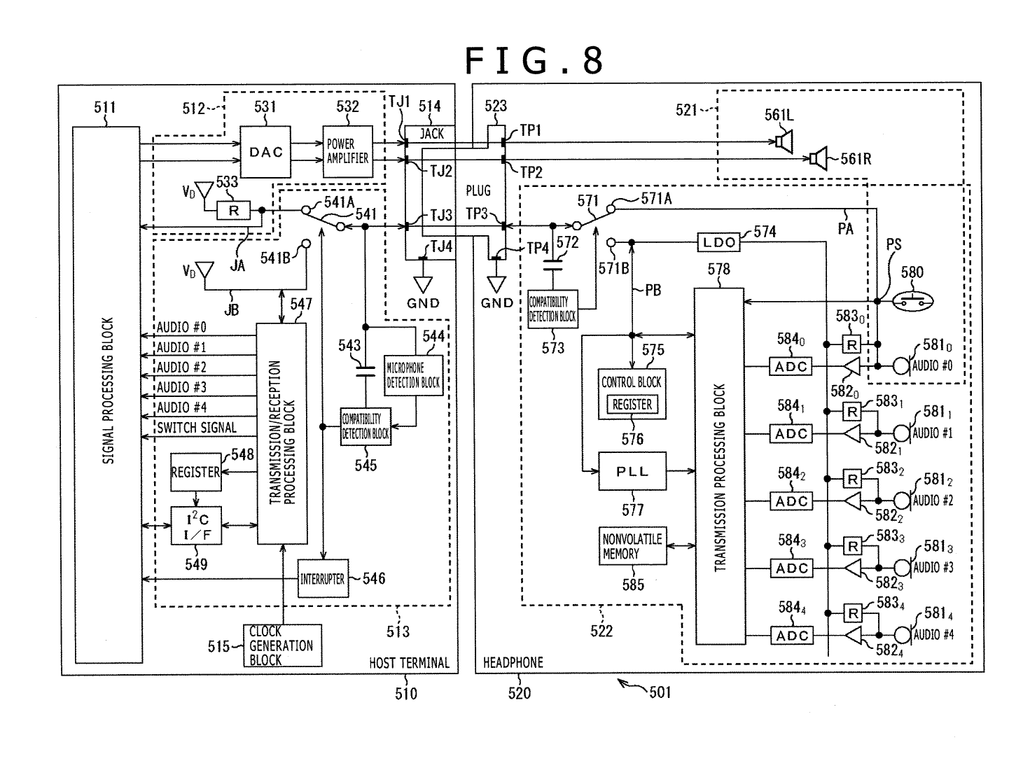

Referring to FIG. 4, there are depicted states of use of one embodiment of the system of the present technology. A noise canceling system 201 as this information processing system is configured by a headphone 211 as an accessory device and a host terminal 212 made up of a smartphone connected to the headphone through a plug 223. It should be noted that the headphone 211 is a headphone compliant with the circuit separated noise canceling (NC) function. Therefore, as depicted in FIG. 4, the headphone 211 is indicated as the NC headphone 211 (this holding with the diagrams subsequent to FIG. 4), however, it is also simply referred to as the headphone 211 as required. The plug 223 corresponds to a plug 523 depicted in FIG. 8 to be described later.

The headphone 211 has a nonvolatile memory 221, a multiplexed data interface 222, and the plug 223. The host terminal 212 has a multiplexed data interface 231, a translator 232, and a noise canceling core (NC core) 233. Although not depicted, the host terminal 212 has a jack (corresponding to a jack 514 depicted in FIG. 8 to be described later) to which the plug 223 of the headphone 211 is connected.

When the plug 223 of the headphone 211 is connected to the host terminal 212 the headphone 211 and the host terminal 212 can execute multiplexed data communication with each other through each the multiplexed data interface 222 and the multiplexed data interface 231. By use of this multiplexed data communication, noise cancelation processing is executed.

A digital audio signal and data can be superposed with each other by multiplexed data communication so as to supply a resultant superposed signal from the headphone 211 to the host terminal 212. Multiplexed data communication is executed by a line (multipolar plug) that connects between a microphone terminal TP3 and the microphone terminal TJ3 depicted in FIG. 8 described later. In addition, the power and the clock can be supplied from the host terminal 212 to the headphone 211. Use of known multiplexed data communication structure can realize the noise canceling function without adding a configuration such as a new plug.

The nonvolatile memory 221 corresponding to the storage block 121 depicted in FIG. 3 stores, as an intermediate parameter, a parameter unique to the headphone 211 that is an accessory device necessary for noise cancelation processing, in addition to a product ID and product model name that are product information. From the headphone 211 to the host terminal 212, an intermediate parameter is supplied by multiplexed data communication through each the multiplexed data interface 222 and the multiplexed data interface 231.

In the host terminal 212, the translator 232 corresponding to the parameter transform block 131 depicted in FIG. 3 transforms the intermediate parameter supplied from the headphone 211 into a native parameter. Upon reception the native parameter from the translator 232, the noise canceling core 233 that is the noise canceling computation block corresponding to the computation block 132 depicted in FIG. 3 executes noise cancelation processing by use of the received native parameter. Specifically, a music signal, for example that is a source sound supplied from the host terminal 212 to the headphone 211 is added with a signal that cancels the noise. As a result, the user 93 of the headphone 211 can listen to the music with the noise canceled or suppressed.

The headphone 211 is made by company A, the host terminal 212 is made by company S, and the translator 232 is made by company Y, however, these products are manufactured in accordance with the standards by these respective companies. Therefore, the headphone 211 cancels the noise of the source sound from the host terminal 212, thereby allowing the user to listen with a good sound quality.

In what follows, the noise cancelation based on the standards using intermediate parameters is referred to as UNC. Further, these standards are written as UNC standard.

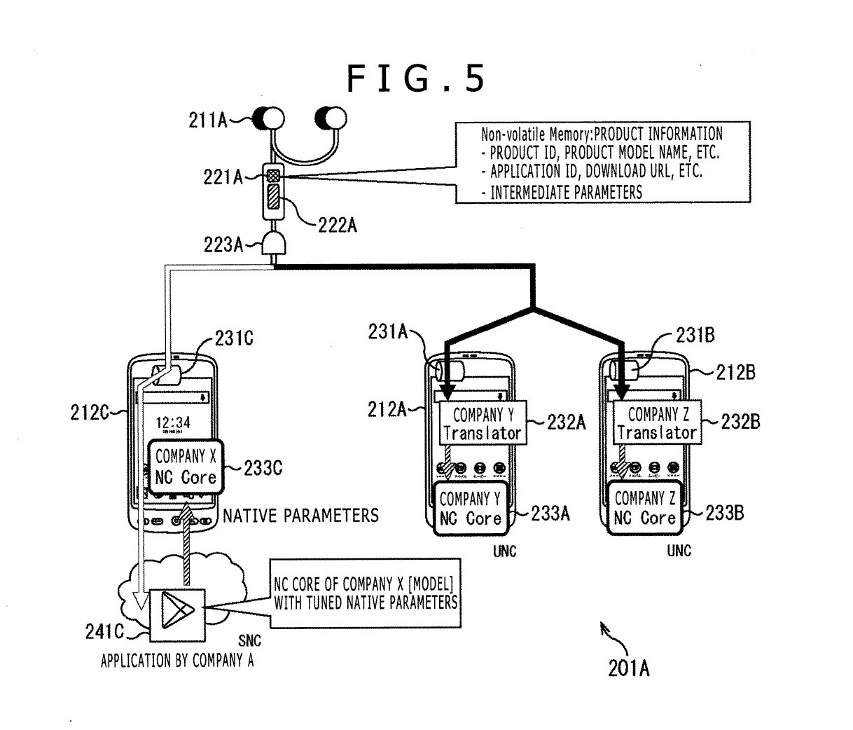

Now, referring to FIG. 5, there is depicted a diagram illustrating states of use of one embodiment of the system of the present technology. In the embodiment depicted in FIG. 5, a noise canceling system 201A that is an information processing system is configured by one unit of a headphone 211A and three units of host terminals 212A, 212B, and 212C. Obviously, at the time of use, the headphone 211A is selectively connected to any one of the three units of host terminals 212A, 212B and 212C.

The headphone 211A manufactured in compliant with the UNC standard is a product of company A and has a nonvolatile memory 221A, a multiplexed data interface 222A, and a plug 223A. The nonvolatile memory 221A stores product information. This product information includes the application ID and the download URL in addition to the product ID and the product model name. Further, a parameter for noise cancelation unique to the headphone 211A as product information is stored as an intermediate parameter.

The host terminal 212A and the host terminal 212B are products of company S and company T, respectively. In the host terminal 212A, a translator 232A and a noise canceling core 233A made by company Y are assembled and, in the host terminal 212B, a translator 232B and a noise canceling core 233B made by company Z are assembled. These products are all manufactured in compliant with the UNC standard. In addition, the host terminal 212A and the host terminal 212B have multiplexed data interfaces 231A and 231B, respectively.

The headphone 211A and the host terminal 212A are manufactured in compliant with the UNC standard. Therefore, if the plug 223A of the headphone 211A is connected to the host terminal 212A, an intermediate parameter stored in the nonvolatile memory 221A is supplied to the translator 232A through the multiplexed data interface 231A. Next, this intermediate parameter is transformed by the translator 232A into a native parameter dedicated to the host terminal 212A. Then, the noise canceling core 233A executes noise cancelation processing by use of this native parameter. As a result, a sound corresponding to as source signal including a noise canceling signal is provided from the host terminal 212A to the user of the headphone 211A, thereby canceling the surrounding noise sound.

The host terminal 212B is also manufactured in compliance with the UNC standard. Therefore, if the plug 223A of the headphone 211A is connected to the host terminal 212B, the intermediate parameter stored in the nonvolatile memory 221A is supplied to the translator 232B through the multiplexed data interface 231B. Then, the intermediate parameter is transformed by the translator 232B into the native parameter dedicated to the host terminal 212B. The noise canceling core 233B executes noise cancelation processing by use of this native parameter. Thus, as with the host terminal 212A, a noise-canceled sound is provided from the host terminal 212B to the user of the headphone 211A.

However, only one set of intermediate parameters is stored in the nonvolatile memory 221A of the headphone 211A. That is, a total of two sets of intermediate parameters, one for host terminal 212A and the other for the host terminal 212B, are not stored. The translator 232A is different from the translator 232B, so that a same intermediate parameter is transformed by each translator into a different native parameter. That is, use of an intermediate parameter realizes the compatibility in the connection between the host terminals 212A and 212B, and the headphone 211A.

Therefore, the data amount of intermediate parameters stored in the nonvolatile memory 221A can be reduced, which in turn reduces the capacity of the nonvolatile memory 221A. In addition, since the amount of data is small, the parameters can be directly stored in the nonvolatile memory 221A without storing in an application. As a result, the application need not be downloaded via a network, thereby realizing the noise canceling function from the time of the initial activation even if no network connectible environment is available.

On the other hand, the host terminal 212C has a multiplexed data interface 231C and a noise canceling core 233C made by company X. The host terminal 212C is made by company S but has no translator because the host terminal 212C is not manufactured in compliant with the UNC standard.

If the plug 223A of the headphone 211A is connected to the host terminal 212C, the noise canceling core 233C reads a download URL and an application ID stored in the nonvolatile memory 221A of the headphone 211A through multiplexed data communication. On the basis of the application ID, the corresponding headphone 211A and host terminal 212C can be identified. Then, the host terminal 212C accesses the URL through a network (not depicted) so as to acquire the application corresponding to the application ID.

The application made by company A thus acquired includes the native parameter for the noise cancelation processing dedicated to the headphone 211A. This native parameter is a dedicated parameter tuned, by an NC core of company X, for the noise acceleration processing in the headphone 211A for the host terminal 212 made by company S. The noise canceling core 233C executes the noise cancelation processing by the native parameter included in this application.

Storing a URL for accessing a parameter requires a function of network connection. By contrast, directly storing an intermediate parameter need not have any network connection environment.

As described above, in the headphone 211A depicted in FIG. 5, the noise canceling function can be realized between any of the host terminals 212A and 212B that satisfy the noise cancelation standards and the host terminal 212C that does not satisfy the noise canceling standards. In what follows, noise cancelation in which not an intermediate parameter but a native parameter (including a URL for acquiring the native parameter and an application ID) is stored in a nonvolatile memory is referred to as specialized noise canceling (SNC).

That is, in order to enable the noise cancelation processing in both modes, UNC mode and SNC mode, the headphone 211A has an intermediate parameter and a native parameter or the information for accessing these parameters.

Note that, if the tuned native parameter, the URL for acquiring this parameter, the application ID, or the like are not stored because the headphone 211A is for the host terminal 212C made by company S, the headphone 211A cannot execute noise cancelation processing with the host terminal 212C.

The noise canceling cores 233A, 233B, and 233C are configured by hardware. These noise canceling cores have different noise cancelation filter coefficients, data bit lengths, and accuracies. In addition, these noise cancelation cores have unique functions developed for enhanced performance with different specifications, and noise cancelation parameters different in format, type, and quantity.

Since the native parameter is a parameter dedicated to each model, an attempt by the headphone 211A to realize the noise canceling function with many types of host terminals requires the tuning for each model and the generation of a native parameter for each model. In turn, this requires storing the native parameter, the URL for accessing this native parameter, the application ID and the like in the nonvolatile memory 221A. This leads to an increased data amount and requires the necessity to increase the capacity of the nonvolatile memory 221A, resulted in pushing up the manufacturing cost.

Further, if user newly buys a headphone, the user must check in advance that the headphone in question is of a type that realizes the noise canceling function with the host terminal of the user's own. Conversely, if the user wants to buy a new host terminal when the user already has a headphone, the same checking job as above is required, making it inconvenient. This inconvenience will not occur if an intermediate parameter is stored instead of a native parameter.

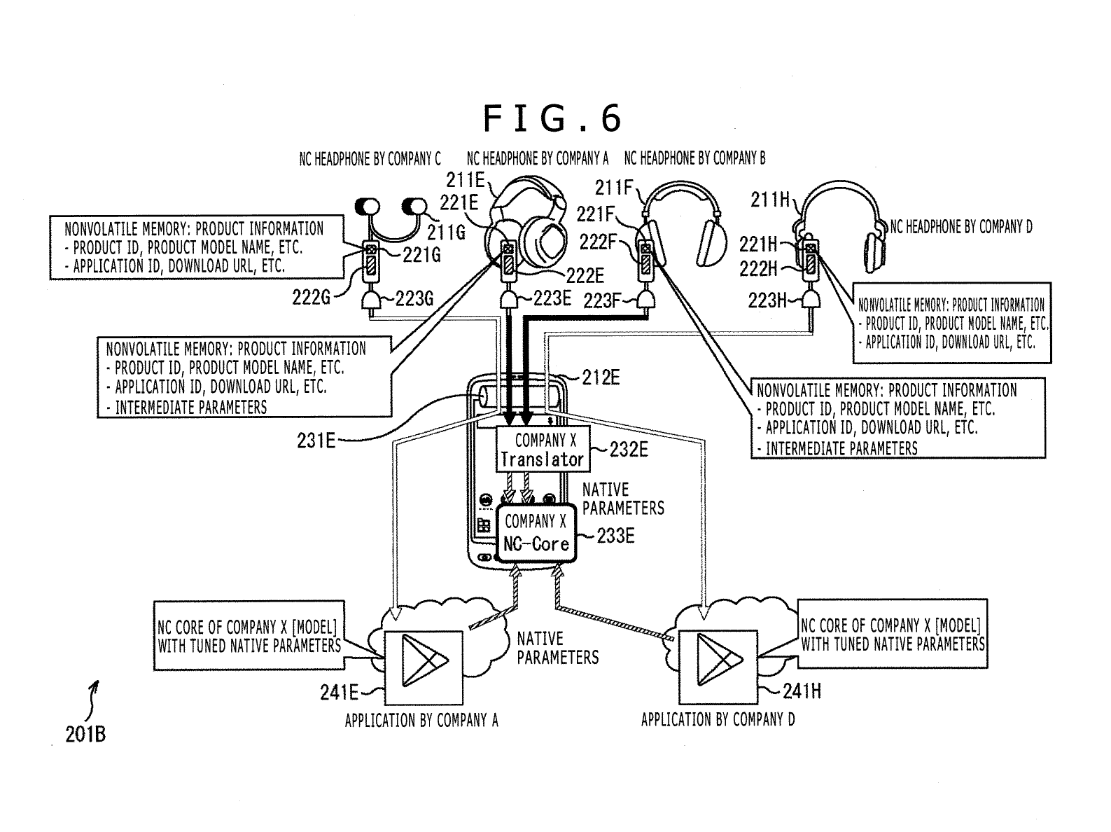

Referring to FIG. 6, there is depicted a diagram illustrating states of use of one embodiment of the system of the present technology. The embodiment depicted in FIG. 5 illustrates an example in which one unit of headphone is connected to two or more host terminals, while the embodiment depicted in FIG. 6 illustrates an example in which one unit of host terminal is connected to two or more headphones.

A noise canceling system 201B that is an information processing system depicted in FIG. 6 is configured by one unit of host terminal 212E and four units of headphones 211E, 211F, 211G, and 211H.

The headphones 211E, 211F, 211G, and 211H have nonvolatile memories 221E, 221F, 221G, and 221H, multiplexed data interfaces 222E, 222F, 222G, and 222H, and plugs 223E, 223F, 223G, and 223H, respectively. The host terminal 212E satisfying the UNC standard has a multiplexed data interface 231E, a translator 232E made by company X, and a noise canceling core 233E made by company X. Obviously, although not depicted, the host terminal 212E has jacks for the connection with the plugs 223E, 223F, 223G, and 223H.

The nonvolatile memories 221E and 221F of the headphones 211E and 221F store application IDs and URLs for downloading in addition to product IDs and product types as production information. Further, since the headphones 211E and 211F satisfy the UNC standard, at least the intermediate parameter for noise cancelation is stored. Accordingly, between the headphones 211E and 211F and the host terminal 212E, noise cancelation processing, namely, UNC is executed as between the headphones 211A and the host terminals 212A and 212B depicted in FIG. 5.

On the other hand, the headphones 211G and 211H do not satisfy the UNC standard. Accordingly, the product information of the nonvolatile memories 222G and 222H thereof store application IDs and the download URLs in addition to product IDs and product model name but do not store the intermediate parameters for noise cancelation.

The application made by company A of the application ID to be downloaded by the download URL stored in the nonvolatile memory 221G of the headphone 211G includes the native parameter for the host terminal 212E made by company S. This native parameter is generated by tuning by the noise canceling core 233E made by company X so as to execute noise cancelation on the signal from the host terminal 212E in which the noise canceling core 233E made by company X is built in in the headphone 211G made by company C. Therefore, SNC is executed in the same manner as between the headphone 211A and the host terminal 212C depicted in FIG. 5.

Likewise, the application made by company D of the application ID to be downloaded by the download URL stored in the nonvolatile memory 221H of the headphone 211H includes the native parameter for the host terminal 212E made by company S. This native parameter is generated by tuning by the noise canceling core 233E made by company X so as to execute noise cancelation on the signal from the host terminal 212E in which the noise canceling core 233E made by company X is built in the headphone 211H made by company D. Therefore, SNC is executed in the same manner as between the headphone 211A and host terminal 212C and between the headphone 211G and the host terminal 212E depicted in FIG. 5.

<4. Basic Operation of a Translator>

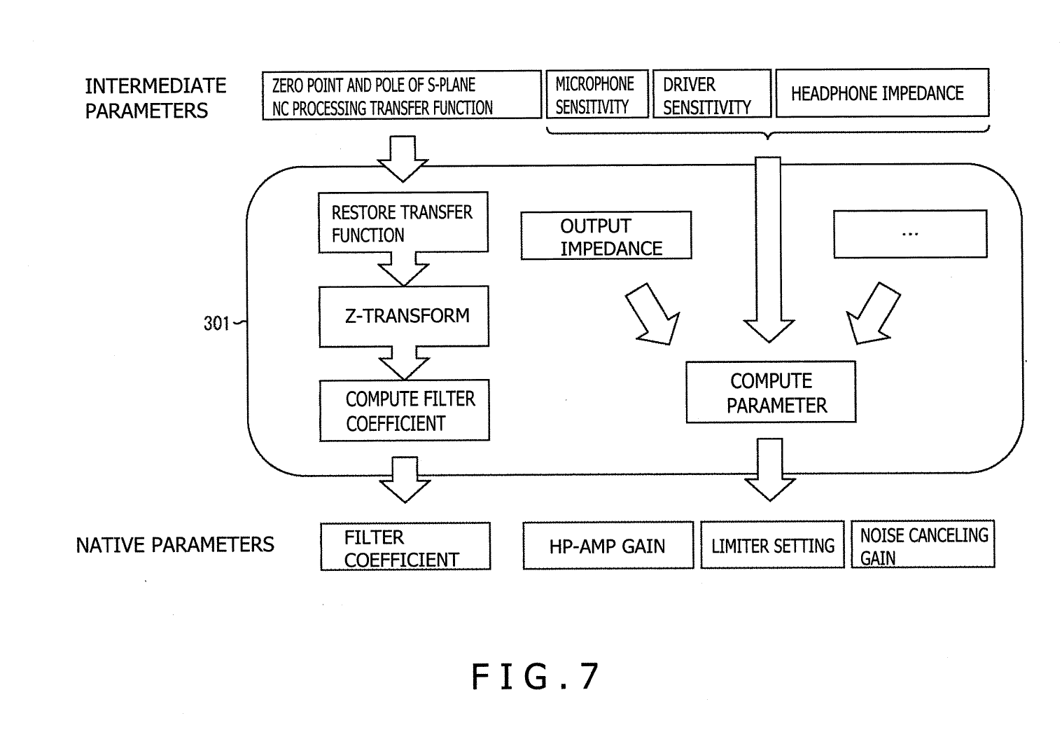

Now, referring to FIG. 7, there is depicted a diagram illustrating a basic operation of a translator. The following describes a basic operation of a translator 301 (corresponding to the parameter transform block 131 depicted in FIG. 3, the translator 232 depicted in FIG. 4, the translators 232A and 232B depicted in FIG. 5, and the translator 232E depicted in FIG. 6) with reference to FIG. 7. As depicted in FIG. 7, an intermediate parameter is configured by transfer function information and physical characteristic information. In the case of this embodiment, transfer function information includes the zero point and pole of a transfer function of noise cancelation processing of s-plane. Physical characteristic information includes microphone sensitivity, driver sensitivity, and headphone impedance.

The translator 301 restores a transfer function from transfer function information, executes Z-translation on the restored transfer function, and then computes a filter coefficient therefrom. The computed filter coefficient makes up a part of a native parameter.

The translator 301 also computes parameters from such physical characteristic information about the headphone 211 (headphones 211A through 211H) as microphone sensitivity, driver sensitivity, and headphone impedance and such information as output impedance. Consequently, such native parameters as a gain of a headphone amplifier (corresponding to the power amplifier 83 depicted in FIG. 2, power amplifiers 532, 582₀, 582₁, 582₂, 582₃, and 582₄ depicted in FIG. 8 to be described later) a limiter setting value, a gain of noise cancelation are generated.

<5. Configuration of One Embodiment of the System of the Present Technology>

Referring to FIG. 8, there is depicted a block diagram illustrating a more detail configuration of one embodiment of the system of the present technology.

It is assumed that a noise canceling system 501 as the present information processing system employs, as a jack 514 and the plug 523, a 4-pole jack and a 4-pole plug (multipolar plug), for example. Here, a host terminal 510 is connected with a headphone 520 as an accessory device.

That is, the jack 514 has two (stereo) audio signal terminals TJ1 and TJ2, one microphone terminal TJ3, and one ground terminal TJ4 and the plug 523 also has two audio signal terminals TP1 and TP2, one microphone terminal TP3, and one ground terminal TP4.

The audio signal terminals TJ1 and TJ2 and TP1 and TP2 are terminals for transferring 2-channel analog audio signals. The audio signal terminals TJ1 and TP1 are terminals for L (Left) channel and the audio signal terminals TJ2 and TP2 are terminals for R (Right) channel.

That is, the audio signal terminal TJ1 is a terminal for outputting an L-channel audio signal and the audio signal terminal TJ2 is a terminal for outputting an R-channel audio signal. The audio signal terminal TP1 is a terminal for receiving an L-channel audio signal and the audio signal terminal TP2 is a terminal for receiving an R-channel audio signal.

The microphone terminals TJ3 and TP3 are terminals for exchanging analog audio signals obtained from a microphone (one of microphones 581₀ through 581₄ to be described later; the microphone 581₀, for example).

The ground terminals TJ4 and TP4 are terminals that are grounded (GND).

When the plug 523 is inserted in the jack 514, the audio signal terminals TJ1 and TP1 are connected with each other, the audio signal terminals TJ2 and TP2 are connected with each other, the microphone terminals TJ3 and TP3 are connected with each other, and the ground terminals TJ4 and PT4 are connected with each other.

Here, some existing headsets are arranged with a driver (headphone driver) that is an audio output block for outputting audio of L and R channels (for example, a transducer configured by a coil, a vibration plate, and so on for transforming an audio signal into a sound (or sound wave as air vibration) (occasionally called as a speaker) and a microphone and have a 4-pole plug.

For the plug 523, a same plug as a 4-pole plug of an existing headset as described above can be employed; for the jack 514, a 4-pole jock corresponding to a 4-pole plug of an existing headset as described above can be employed.

In this case, the plug 523 can be inserted in a jack (4-pole jack) of a jack device such as an existing music player or the like that can use an existing 4-pole headset (having a plug). In addition, the plug (4-pole plug) of an existing 4-pole headset can be inserted in the jack 514.

It should be noted that the plug 523 is configured such that, when the plug 523 is inserted in a 3-pole jack having no microphone terminal equivalent to the microphone terminal TJ3, the audio signal terminals TP1 and TP2 of the plug 523 are connected to an audio signal terminal of the 3-pole jack and the ground terminal TP4 of the plug 523 is connected to the ground terminal of the 3-pole jack, thereby making the microphone terminal TJ3 of the plug 523 prevent the short-circuiting between the terminals. The same holds with the jack 514.

Further, the plug 523 is not limited to a same plug as the 4-pole plug of an existing headset and not limited to any 4-pole plugs. That is, a plug that can be employed for the plug 523 include a 3-pole plug having one (monaural) audio signal terminal TP1, one microphone terminal TP3, and one ground terminal TP4 or a 5-pole or a more-than-5-pole plug having a separate microphone terminal and terminal for a predetermined signal in addition to two audio signal terminals TJ1 and TJ2, one microphone terminal TJ3, and one ground terminal TJ4. It should be noted that a plug having many poles (terminals) becomes complicated in configuration, so that for the plug 523, a plug that does not have too many poles, specifically, a 4-pole plug, a 5-pole plug, or a 6-pole plug can be employed.

The description made above also holds with the jack 514.

Here, in FIG. 8, the 4-pole plug 523 is arranged directly on the main body of the headphone 520 so to speak for the brevity of drawing. The 4-pole plug 523 can be directed connected to the main body of the headphone 520 through a 4-core cable.

With the host terminal 510 as a smartphone, an analog audio interface 512 has a digital analog converter (DAC) 531, a power amplifier (headphone amplifier) 532, and a resistor (R) 533.

The DAC 531 is supplied from a signal processing 511 with digital audio signals of L channel and R channel, namely, audio signals of music reproduced at the host terminal 510 functioning as a music player, for example, and an audio signal of the voice of the other party of a telephone call received by the host terminal 510 that functions as a telephone set.

The DAC 531 executes digital to analog (DA) transform on the digital audio signals of L channel and R channel from the signal processing block 511 to obtain analog audio signals of L channel and R channel, supplying the obtained analog audio signals to the power amplifier 532.

The power amplifier 532 amplifies the analog audio signals of L channel and R channel from the DAC 531 as required and outputs the amplified analog audio signals to the audio signal terminals TJ1 and TJ2 of the jack 514.

If the plug 523 is inserted in the jack 514, the audio signal terminals TJ1 and TP1 are connected and the audio signal terminals TJ2 and TP2 are connected as described above, so that the analog audio signals of L channel and R channel outputted to the audio signal terminals TJ1 and TJ2 of the jack 514 are outputted to the audio signal terminals TP1 and TP2 of the plug 523, respectively.

One end of the resistor 533 is connected to a power supply VD and the other end is connected to a terminal 541A of a switch 541.

In the host terminal 510 as a smartphone, a multiplexed data interface 513 has a switch 541, a capacitor 543, a microphone detection block 544, a compatibility detection block 545, an interrupter 546, a transmission/reception processing block 547, a register 548, and an inter-integrated circuit (I2C) interface (I/F) 549.

The switch 541 has terminals 541A and 541B and is connected to the microphone terminal TJ3 of the jack 514. The switch 541 switches between the terminals 541A and 541B so as to connect the microphone terminal TJ3 of the jack 514 to the terminal 541A or 541B.

In default, namely, in an initial state, a standby state, a state in which nothing is inserted in the jack 514, or a state in which no switching of the switch 541 is executed to select the terminal 541B, the switch 541 selects the terminal 541A from the terminals 541A and 541B.

The terminal 541A is connected to the other end of the resistor 533 as described above and to an audio signal line JA that is a signal line for receiving an analog audio signal #0 outputted from the microphone 581₀ to be described later.

The audio signal line JA connects the terminal 541A with the signal processing block 511 and, when the switch 541 selects the terminal 541A (eventually the audio signal line JA connected to the terminal 541A), the signal processing block 511 is connected to the microphone terminal TJ3 of the jack 514 through the audio signal line JA connected to the terminal 541A and the switch 541.

It should be noted that, as described above, the terminal 541A is also connected with the other end of the resistor 533 with one end thereof connected to the power supply VD. When the switch 541 selects the terminal 541A, the power supply VD is also connected to the resistor 533, and the microphone terminal TJ3 of the jack 514 through the switch 541.

The terminal 541B is connected to a multiplexed data signal line JB for receiving multiplexed data transmitted from the headphone 520.

The multiplexed data signal line JB is connected to the power supply VD and the transmission/reception processing block 547 in addition to the terminal 541B. Accordingly, when the switch 541 selects the terminal 541B (eventually the multiplexed data signal line JB connected to the terminal 541B), the power supply VD and the transmission/reception processing block 547 are connected to the microphone terminal TJ3 of the jack 514 through the multiplexed data signal line JB and the switch 541.

One end of the capacitor 543 is connected to the microphone terminal TJ3 of the jack 514 and the other end is connected to the compatibility detection block 545, thereby cutting the direct-current component of a signal that passes the capacitor 543.

The microphone detection block 544 monitors the voltage of the microphone terminal TJ3 of the jack 514.

When the plug 523 is inserted in the jack 514, the microphone terminals TJ3 and TP3 are connected and the microphone 581₀ of the headphone 520 is connected to the power supply VD through a switch 571, the microphone terminal TP3 of the plug 523, the microphone terminal TJ3 of the jack 514, the switch 541, and the resistor 533.

In this case, the microphone 581₀ of the headphone 520 becomes a direct-current resistance (component) of several kilohms for the host terminal 510, thereby changing the voltage of the microphone terminal TJ3 of the jack 514. This voltage changes makes the microphone detection block 544 detect the connection of a microphone, namely, the insertion of a plug device (plug thereof) having a microphone such as a headset with a 4-pole plug into the jack 514. It should be noted that, in addition to the voltage of the microphone terminal TJ3, the microphone detection block 544 can detect the connection of a microphone on the basis of a signal change other than that of voltage, such as a current flowing across the microphone terminal TJ3.

Upon detection of the connection of a microphone, the microphone detection block 544 supplies a microphone detection signal indicative of the detection of a microphone to the compatibility detection block 545.

When a microphone detection signal is supplied from the microphone detection block 544, namely, a plug of a plug device having a microphone is inserted in the jack 514, the compatibility detection block 545 outputs a handshake signal for detecting whether or not the plug device is a compatible device.

The handshake signal outputted from the compatibility detection block 545 is supplied to the microphone terminal TJ3 of the jack 514 through the capacitor 543.

Here, for the handshake signal, a sinewave of several tens to several hundred kHz, for example, can be employed.

As described above, the compatibility detection block 545 detects that the plug device inserted in the jack 514 is a compatible device if the compatibility detection block 545 receives a predetermined signal answering the handshake signal from the microphone terminal TJ3 of the jack 514 through the capacitor 543 after the microphone detection signal is supplied from the microphone detection block 544 and the handshake signal is outputted.

If the plug device with the plug inserted in the jack 514 is detected to be a compatible device, then the compatibility detection block 545 switches the switch 541 selecting the terminal 541A to the terminal 541B and supplies information about this switching of the switch 541 to the interrupter 546.

When the information about the switching of the switch 541 to the terminal 541B is supplied from the compatibility detection block 545, the interrupter 546 supplies information about the insertion of the compatible device (plug thereof) into the jack 514 to the signal processing block 511.

It should be noted that the interrupter 546 supplies the information about the insertion of the compatible device into the jack 514 to the signal processing block 511 if the information about the switching of the switch 541 to the terminal 541B is supplied from the compatibility detection block 545 to the interrupter 546. Whether or not the compatible device is inserted in the jack 514 can be inquired from the signal processing block 511 to the interrupter 546 by executing polling on a regular (or an irregular) basis.

When the information about the insertion of the compatible device into the jack 514 is supplied from the interrupter 546, the signal processing block 511 executes the signal processing for the compatible device.

The transmission/reception processing block 547 is supplied with a clock from a clock generation block 515 and operates in synchronization with the clock supplied from the clock generation block 515.

Then, when the switch 541 selects the terminal 541B, the transmission/reception processing block 547 receives multiplexed data through the microphone terminal TJ3 of the jack 514, the switch 541, and the multiplexed data signal line JB.

In addition, the transmission/reception processing block 547 executes proper processing on the multiplexed data, such as demultiplexing (or deserializing) (demodulating) of the multiplexed data so as to separate such original data included in the multiplexed data as digital audio signals #0, #1, #2, #3, and #4, and additional data, for example.

In the present embodiment, the multiplexed data includes digital audio signals #0, #1, #2, #3, and #4, and additional data, for example.

The digital audio signals #0, #1, #2, #3, and #4 are digital audio signals corresponding to the audio signals picked up by the microphones 581₀, 581₁, 581₂, 581₃, and 581₄, respectively, to be described later.

Further, the additional data includes switch (SW) signals indicative of operations of the switch 580 to be described later, device information to be described later, and other data.

The transmission/reception processing block 547 supplies the audio signals #0, #1, #2, #3, and #4 and switch signals included in the additional data to the signal processing block 511, supplies the device information and other data included in the additional data to the register 548 or to the signal processing block 511 through the I2C interface 549.

Here, the signal processing block 511 uses the audio signals #0, #1, #2, #3, and #4 supplied from the transmission/reception processing block 547, the switch signals, and the data (information) supplied through the I2C interface 549 as required, thereby executing various signal processing operations in accordance with the device information.

That is, the signal processing block 511 can use the digital audio signals #1 through #4, for example so as to execute NC processing to be described later on the music audio signal supplied to the DAC 531 as the signal processing in accordance with the device information. In addition, the signal processing block 511 can use the digital audio signals #01 through #4, for example so as to execute such processing as beam forming as the signal processing in accordance with the device information.

When the switch 541 selects the terminal 541B, the transmission/reception processing block 547 receives multiplexed data as described above and, in response to a request supplied from the signal processing block 511 through the I2C interface 549, transmits a command for a corresponding device to a plug device that is a corresponding device with a plug thereof inserted in the jack 514 through the multiplexed signal data signal line JB, the switch 541, and the microphone terminal TJ3 of the switch 541.

The register 548 temporarily stores device information and the like supplied from the transmission/reception processing block 547.

The I2C interface 549 functions as an interface between the transmission/reception processing block 547 and the signal processing block 511 by connecting these blocks by the specifications of I2C.

In the headphone 520 as a headset, an analog audio interface 521 has drivers 561L and 561R, a switch (button) 580, and the microphone 581₀.

The drivers 561L and 561R are drivers (headphone drivers) (transducers configured by a coil and vibration plate, for example, that transform an audio signal into a sound (sound wave) that is a vibration of the air) as an audio output block for outputting a sound, each outputting (sounding) a sound corresponding to audio signals supplied from the audio signal terminals TP1 and TP2.

As described above, when the plug 523 is inserted in the jack 514, the audio signal terminals TJ1 and TP1 are connected and the audio signal terminals TJ2 and TP2 are connected, upon which the music audio signals and the like reproduced in the host terminal 510, for example, are outputted from the signal processing block 511 to the audio signal terminals TP1 and TP2 of the plug 523 through the DAC 531, the power amplifier 532, and the jack 514.

As a result, in the drivers 561L and 561R, the sounds corresponding to the audio signals such as music and the like reproduced in the host terminal 510 are outputted.

A switch 580 that is operated to change switch signals (impedance of the switch 80 as seen from a connection point PS) that are (direct current) voltages at the connection point PS to which the switch 580 is connected, depending on the state that the switch 580 is operated and the switch 580 is not operated by a user. The switching signal (H or L level) of the switch 580 is supplied to a terminal 571A of the switch 571 and to a transmission processing block 578.

The microphone 581₀ is a transducer that coverts a sound (sound wave) that is a physical quantity into an audio signal that is an electrical signal, outputting an analog audio signal corresponding to a sound picked up by the microphone 581₀.

Here, the microphone 581₀ can be used as a voice microphone intended to pick up the voice of a user who wears the headphone 520 that is a headset, for example.

The output terminal of the microphone 581₀ is connected to an amplifier 582₀, a resistor (R) 583₀, and a connection point PS to which a switch signal of the switch 580 is outputted, the connection point PS being connected to the terminal 571A of the switch 571.

Therefore, at the connection point PS, the switch signal of the switch 580 is superposed with an analog audio signal outputted from the microphone 581₀ so as to be supplied to the terminal 571A of the switch 571.

It should be noted that the switch 580 and the microphone 581₀ not only make up the analog audio interface 521 as described above, but also make up a multiplexed data interface 522 to be described later.

In the headphone 520 that is a headset, the multiplexed data interface 522 has the switch 571, a capacitor 572, a compatibility detection block 573, a low drop-out regulator (LDO) 574, a control block 575, a phase locked loop (PLL) 577, the transmission processing block 578, the switch 580, the microphones 581₀, 581₁, 581₂, 581₃, and 581₄, amplifiers 582₀, 582₁, 582₂, 582₃, and 582₄, resisters 583₀, 583₁, 583₂, 583₃, and 583₄, ADCs 584₀, 584₁, 584₂, 584₃, and 584₄, and a nonvolatile memory 585.

The switch 571 has the terminals 571A and 571B which are connected to the microphone terminal TP3 of the plug 523. The switch 571 selects the terminal 571A or the 571B so as to connect the microphone terminal TP3 of the plug 523 to the terminal 571A or 571B.

In default, the switch 571 selects the terminal 571A from the terminals 571A and 471B.

The terminal 571A is connected with an audio signal line PA that is a signal line for transmitting an analog audio signal #0 outputted from the microphone 581₀.

The audio signal line PA connects the terminal 571A to the connection point PS. When the switch 571 selects the terminal 571A (eventually, the audio signal line PA connected to the terminal 571A), the connection point PS is connected to the microphone terminal TP3 of the plug 523 through the audio signal line PA connected to the terminal 571A and the switch 571.

Therefore, at the connection point PS, the analog audio signal superposed with a switch signal of the switch 580, the analog audio signal being outputted by the microphone 581₀, is outputted to the microphone terminal TP3 of the plug 523 through the audio signal line PA and the switch 571 selecting the terminal 571A.

The terminal 571B is connected with the multiplexed data signal line PB for transmitting multiplexed data outputted from the transmission processing block 578 to the host terminal 510.

The multiplexed data signal line PB is connected with the control block 575, the PLL 577, and the transmission processing block 578 in addition to the terminal 571B; therefore, when the switch 571 selects the terminal 571B (eventually the multiplexed data signal line PB connected to the terminal 571B), the control block 575, the PLL 577, and the transmission processing block 578 are connected to the microphone terminal TP3 through the multiplexed data signal line PB and the switch 571.

Further, the terminal 571B is connected with an LDO 574 in addition to multiplexed data signal line PB; when the switch 571 selects the terminal 571B, the LDO 574 is also connected to the microphone terminal TP3 of the plug 523 through the switch 571.

One end of the capacitor 572 is connected to the microphone terminal TP3 of the plug 523 and the other end is connected to the compatibility detection block 573, thereby cutting the direct-current component of a signal passing the capacitor 572.

Receiving a handshake signal from the microphone terminal TP3 of the plug 523 through the capacitor 572, the compatibility detection block 573 detects that a jack device having a jack inserted with the plug 523 is a compatible device.

If the jack device with the jack inserted with the plug 523 is found to be a compatible device, then the compatibility detection block 573 switches the switch 571 so as to switch from the terminal 571A to the terminal 571B and, in order to notify the jack device with the jack inserted in the plug 523 that the headphone 520 is a compatible device, outputs a handshake signal similar to or different in frequency from the received handshake signal to the microphone terminal TP3 of the plug 523 through the capacitor 572.

The LDO 574 is a voltage regulator that generates a predetermined voltage from a signal supplied from the microphone terminal TP3 of the plug 523 through the switch 571 and supplies the generated voltage to an amplifier 582ᵢ through a resistor 583ᵢ as a power source and supplies the power to the control block 575, the transmission processing block 578, the ADC 584ᵢ, and other power requiring blocks of the multiplexed data interface 522.

Therefore, the multiplexed data interface 522 of the headphone 520 operates on the power supplied from the host terminal 510 (power supply VD thereof).

It should be noted that signal lines for the LDO 574 to supply the power to each block are appropriately omitted for the brevity of illustration.

The control block 575 incorporates a register 576 and executes processing as instructed by the values stored in the register 576.

Further, in accordance with a signal (command) supplied from the microphone terminal TP3 of the plug 523 through the switch 571 (selecting the terminal 571B) and the multiplexed data signal line PB, the control block 575 writes data to the register 576, reads data from the register 576 and the nonvolatile memory 585, and executes other processing operations.

Here, in reading data from the register 576, the control block 575 reads data from the register 576 and supplies the data to the transmission processing block 578. In the transmission processing block 578, the data from the control block 575 is included on multiplexed data to be transmitted from the microphone terminal TP3 of the plug 523 through the multiplexed data signal line PB and the switch 571.

In reading data from the nonvolatile memory 585, the control block 575 controls the transmission processing block 578 so as to read data from the nonvolatile memory 585, this data being included in multiplexed data to be transmitted from the microphone terminal TP3 of the plug 523 through the multiplexed data signal line PB and the switch 571.

It should be noted that the control block 575 executes the control of blocks required by the headphone 520 as necessary. Signal lines for the control block 575 to execute the control of necessary blocks are appropriately omitted for the brevity of illustration.

When the switch 571 selects the terminal 571B, the PLL 577 is supplied with a signal from a jack device (compatible device) having a jack inserted with the plug 523 through the microphone terminal TP3 of the plug 523, the switch 571, and the multiplexed data signal line PB.

The PLL 577 generates a clock in synchronization with the signal supplied through the microphone terminal TP3 of the plug 523, the switch 571, and the multiplexed data signal line PB and supplies the generated clock to the transmission processing block 578 and other necessary blocks.

The transmission processing block 578 is supplied with a switch signal (H or L level indicative whether or not the switch 580 is operated) and from the ADC 584ᵢ (i=0, 1, 2, 3, 4), an audio signal #i that is a one-bit digital signal, for example of a sound picked up by the microphone 581ᵢ.

The transmission processing block 578 operates in synchronization with a clock supplied from the PLL 577, executes (time division) multiplexing (serialization) (modulation) and other necessary processing operations on the switch signal from the switch 580, the digital audio signal #i from the ADC 584ᵢ, the data read from the register 576, and the data (device information) read from the nonvolatile memory 585, and transmits the resultant multiplexed data from the microphone terminal TP3 of the plug 523 through the multiplexed data signal line PB and the switch 571.

Here, as described above, the multiplexed data include the digital audio signals #0, #1, #2, #3 and #4 and additional data. The additional data implies the switch signal, the data read from the register 576, and the data read from the nonvolatile memory 585.

The microphone 581ᵢ is a transducer for transforming a sound (sound wave) that is a physical quantity into an audio signal that is an electrical signal and outputs an analog audio signal #i corresponding to a sound #i to be entered in the microphone 581ᵢ.

Here, the microphone 581₀ can be used as an audio microphone intended to pick up the voice of a user who wears the headphone 520 as a headset as described above.

In addition, the microphones 581₁ through 581₄ can be used as NC microphones intended to pick up the sounds such as noise and the like for use in NC processing executed in the signal processing block 511 of the host terminal 510, for example.

The analog audio signal #i outputted by the microphone 581ᵢ is supplied to the amplifier 582ᵢ.

The amplifier 582ᵢ amplifies the analog audio signal #i supplied from the microphone 581ᵢ and supplies the amplified signal to the ADC 584ᵢ.

The resistor 583ᵢ is connected between the output terminal of the LDO 574 and the connection point between the microphone 581ᵢ and the amplifier 582ᵢ.

The ADC 584ᵢ executes AD transform on the analog audio signal #i from the amplifier 582ᵢ and supplies a resultant digital audio signal #i to the transmission processing block 578.

Here, for the AD transform by the ADC584ᵢ, Δσ modulation as one-bit AD transform can be employed, for example.

The nonvolatile memory 585 is a one time programmable (OTP) memory or an erasable programmable read only memory (EPROM), for example, and stores device information.

The device information denotes information related with the headphone 520; the device information can include a vendor ID and the like for identifying the maker of the headphone 520 and the product ID and the like for identifying the model of the headphone 520 (entity). Further, the device information can also include UNC intermediate parameters and SNC parameters (application ID and so on).

In addition, the device information can include configuration-and-function information indicative of the configuration, functions, and purposes of use of the headphone 520.

For the configuration-and-function information, information that the headphone 520 is a headset and the number of transducers such as the microphone 581ᵢ arranged on the headphone 520 can be employed, for example.

Further, when the headphone 520 is used with plug 523 of the headphone 520 inserted in the jack 514 of the host terminal 510, the device information can include processing information and so on for the headphone 520 to execute optimum (or proper) processing in the signal processing block 511.

Employment for the processing information includes, if NC processing is executed in the signal processing block 511 of the host terminal 510 as a smartphone functioning as a music player, for example, an NC processing algorithm for the execution of the optimum NC processing for the headphone 520 as a headset, a filter coefficient of a filter used in NC processing, the characteristic of the microphone 581ᵢ usable for obtaining this filter coefficient, and characteristics of the drivers 561L and 561R, for example.

It should be noted that, in FIG. 8, the headphone 520 has one switch 580; however, it is also practicable for the headphone 520 to have two or more switches (in parallel to the connection point PS). In addition, the headphone 520 can be configured with no switch arranged.

Further, as depicted in FIG. 8, although the headphone 520 has five microphones 581₀ through 581₄, the headphone 520 can have more than five microphones.

Still further, in addition to microphones, the headphone 520 can have a transducer for transforming a physical quantity into an electrical signal, namely, an acceleration sensor, a touch sensor, or a biosensor for sensing such physical quantities related with living bodies as body temperatures and beats, for example.

The multiplexed data interface 513 of the host terminal 510 depicted in FIG. 8 corresponds to the multiplexed data interface 231 of the host terminal 212 depicted in FIG. 4, the multiplexed data interfaces 231A, 231B, and 231C of the host terminals 212A, 212B, and 212C depicted in FIG. 5, and the multiplexed data interface 231E of the host terminal 212E depicted in FIG. 6. These are also referred to as master core.

The multiplexed data interface 522 of the headphone 520 depicted in FIG. 8 corresponds to the multiplexed data interface 222 of the headphone 211 as an accessory device depicted in FIG. 4, the multiplexed data interface 222A of the headphone 211A as an accessory device depicted in FIG. 5, and the multiplexed data interfaces 222E, 222F, 222G, and 222H of the headphones 211E, 211F, 211G, and 211H as accessory devices depicted in FIG. 6. These are also referred to as slave core.

It should be noted that, in the embodiments depicted in FIG. 4, FIG. 5, and FIG. 6, in addition to the multiplexed data interfaces 222, 222A, 222E, 222F, 222G, and 222H, the corresponding nonvolatile memories 221, 221A, 221E, 221F, 221G, and 221H are indicated. By contrast, in FIG. 8, the nonvolatile memory 585 is indicated as accommodated inside the multiplexed data interface 522.

<6. Operation of One Embodiment of the System of the Present Technology>

The headphone compatible with UNC requires NC filter characteristics as an intermediate parameter to be stored in the nonvolatile memory 585 inside the multiplexed data interface 522 (slave core) in order to compute native parameters. The intermediate parameter is a characteristic in s-plane so as to exclude the influences of the noise canceling core included in the signal processing block 511 and the specifications of the host terminal 510. In addition, in order to exclude the influence of filter configuration, the zero point and pole of a transfer function are stored. The transfer function is as indicated by the following expression.

$$\begin{matrix}[ Mathematical expression 1 ] & \\ F ( s ) = \frac{( s - {z}_{1} ) ( s - {z}_{2} )}{( s - {p}_{1} ) ( s - {p}_{2} )} … \frac{( s - {z}_{8} )}{( s - {p}_{8} )} & ( 4 )\end{matrix}$$

In expression (4) above, the maximum number of zero points is eight and the maximum number of poles is eight.

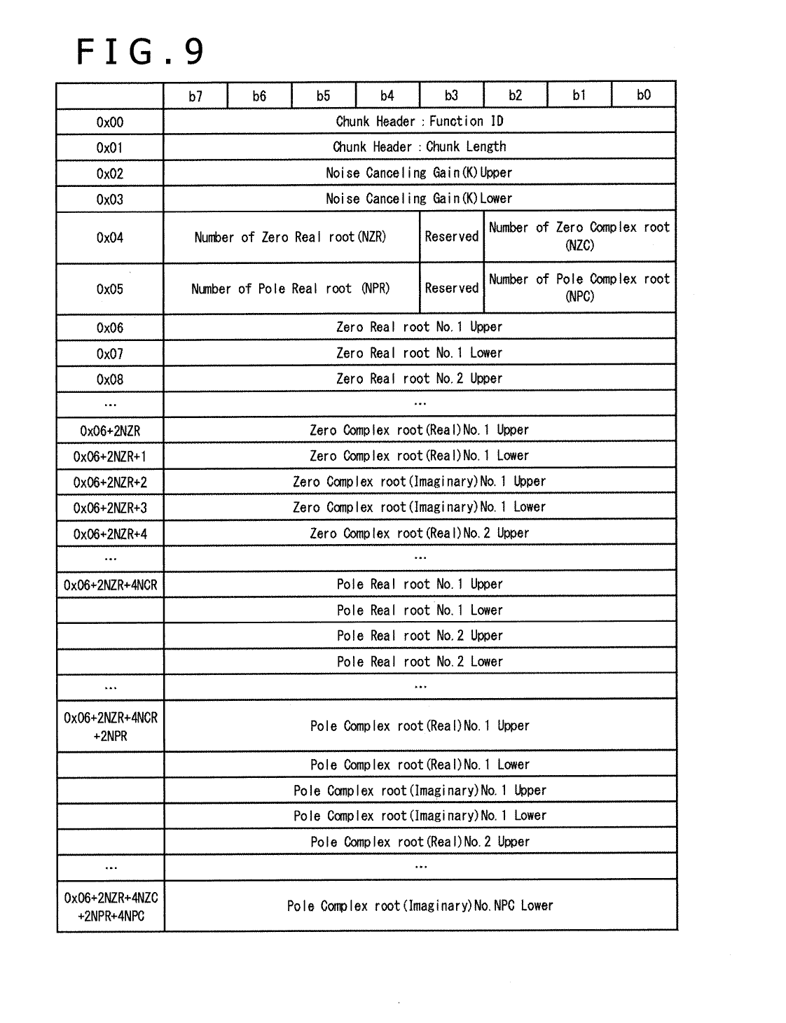

FIG. 9 depicts an example illustrating a format in which an intermediate parameter is stored in the nonvolatile memory 585. Here, one chunk, which means “intermediate parameter,” is defined. Obviously, if the host terminal 510 can acquire an intermediate parameter corresponding to the model of a connected NC headphone, no chunk structure is required. Alternatively, it is also practicable to acquire an intermediate parameter on a network server without storing an intermediate parameter in the nonvolatile memory 585.

FIG. 9 illustrates the format of an intermediate parameter. As depicted in FIG. 9, a function ID is arranged in the start eight-bit header of an intermediate parameter chunk and a chunk length in the header that follows. Subsequently, the higher eight bits and lower eight bits of gain K of a transfer function in the s-plane of noise canceling are sequentially arranged. Further, the number of real roots (four bits), the number of zero-point complex roots (three bits), the number of pole real roots (four bits), and the number of pole complex roots (three bits) of zero-point of the transfer function in the s-plane of noise canceling are arranged.

Subsequently, the higher eight bits and the lower eight bits of the zero-point real roots are stored in a predetermined sequence. Further, the higher eight bits and lower eight bits of the real number part of zero-point complex roots and the higher eight bits and lower eight bits of the imaginary number part of zero-point complex roots are sequentially stored. In addition, the higher eight bits and lower eight bits of the pole real roots are stored. Subsequently, the higher eight bits and lower eight bits of the real number part of pole complex roots and the higher eight bits and lower eight bits of the imaginary number part of pole complex roots are sequentially stored.

A translator is installed on the host terminal 510 having the UNC-compatible noise canceling function, the translator transforms an intermediate parameter into a native parameter and sets the native parameter to a noise canceling core. In addition, for the noise canceling cores, the specifications of a degree that allows intermediate parameters are required. It should be noted that, in the embodiment depicted in FIG. 8, these are all included in the signal processing block 511.

For example, the degree necessary for an NC filter is automatically determined from the number of zero points and poles in the standard. In the present embodiment, the numbers of zero points and poles are each eight at maximum, so that the NC filter must have performance equivalent to eight degrees.

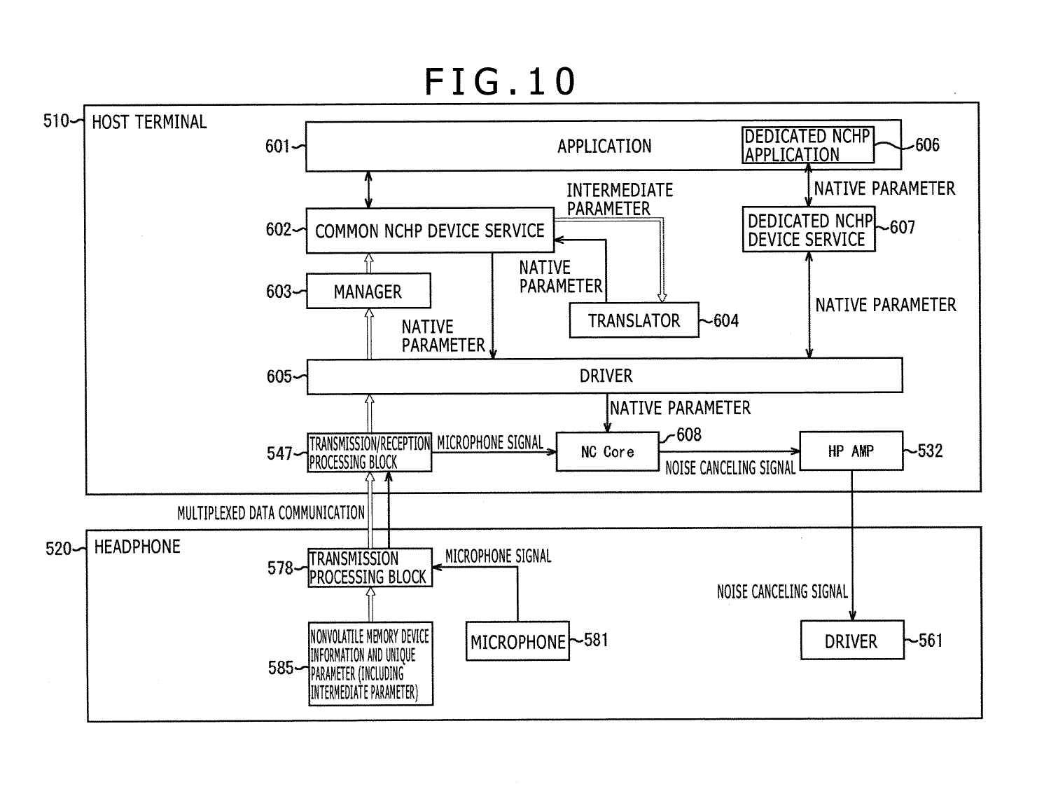

Now, referring to FIG. 10, there is depicted a diagram illustrating basic operations of the host terminal and the headphone. In FIG. 10, a music reproduction signal is not related with the essence of the present technology and therefore not illustrated for brevity. In FIG. 10, a driver 605 is a driver for controlling noise cancelation processing. A manager 603 activates a dedicated NCHP device service 607 compatibly corresponding to the headphone 520 that is a connected accessory device and manages a life cycle from activation to termination of this service. It should be noted that, in FIG. 10, the dedicated NCHP device service 607 is a service for a noise canceling headphone (NCHP), so that it is indicated as an NCHP device service. The dedicated NCHP device service 607 is also indicated simply as a dedicated device service 607 as necessary.

The dedicated NCHP device service 607 mainly controls the headphone 520 and provides the function of the headphone 520 to an application 601. Of the device services, a common NCHP device service 602 provides functions related with UNC. Since the common NCHP device service 602 is also a common device service for an NCHP, it is indicated as a common NCHP device service in FIG. 10. The common NCHP device service 602 is also indicated simply as the common device service 602 as necessary. The dedicated device service 607 mainly provides functions related with SNC among the device services. The application 601 realizes an application that uses the headphone 520.

An input in a translator 604 is an intermediate parameter stored in the nonvolatile memory 585 of the headphone 520 and an output from the translator 604 is a native parameter corresponding to a noise canceling core 608 installed on the host terminal 510.

The translator 604 first restores a transfer function in the s-plane from the zero point and pole written in an intermediate parameter and gain information. This transfer function is expressed by the above-mentioned expression (4). On the basis of this transfer function (expression (4)), the translator 604 generates a native parameter corresponding to the noise canceling core 608 installed on the host terminal 510.

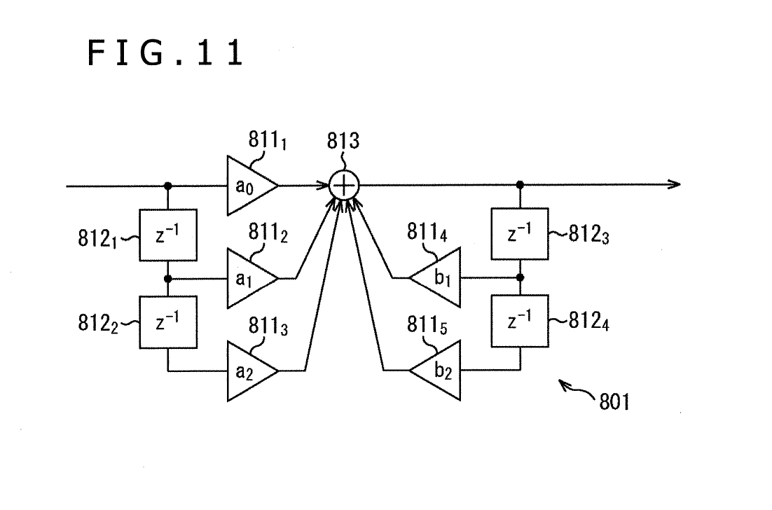

For example, assume that the maximum number of zero points and poles be eight each and the filter of the noise canceling core 608 be configured as depicted in FIG. 11 for a simple example for description although a minimum NC filter configuration obtained from the eight zero points and eight poles is transgressed.

FIG. 11 is a block diagram illustrating a configuration of an NC filter. This NC filter 801 is configured by multipliers 811₁, 811₂, 811₃, 811₄, and 811₅ for multiplying an input by coefficients (gains) a₀, a₁, a₂, b₁, and b₂ and outputting the result of the multiplication to an adder 813 and delay circuits 812₁, 812₂, 812₃, and 812₄ for delaying an input by one clock and outputting the result of the delay. The delay circuit 812₁ delays an input into the NC filter 801 and outputs the result of the delay to the multiplier 811₂. The delay circuit 812₂ delays the input from the delay circuit 812₁ and outputs the result of the delay to the multiplier 811₃. The delay circuit 812₃ delays the output from the adder 813 and outputs the result of the delay to the multiplier 811₄. The delay circuit 812₄ delays the input from the delay circuit 812₃ and outputs the result of the delay to the multiplier 811₅. The adder 813 adds the outputs from the multipliers 811₁, 811₂, 811₃, 811₄, and 811₅ and outputs the result of the addition to the NC filter 801.

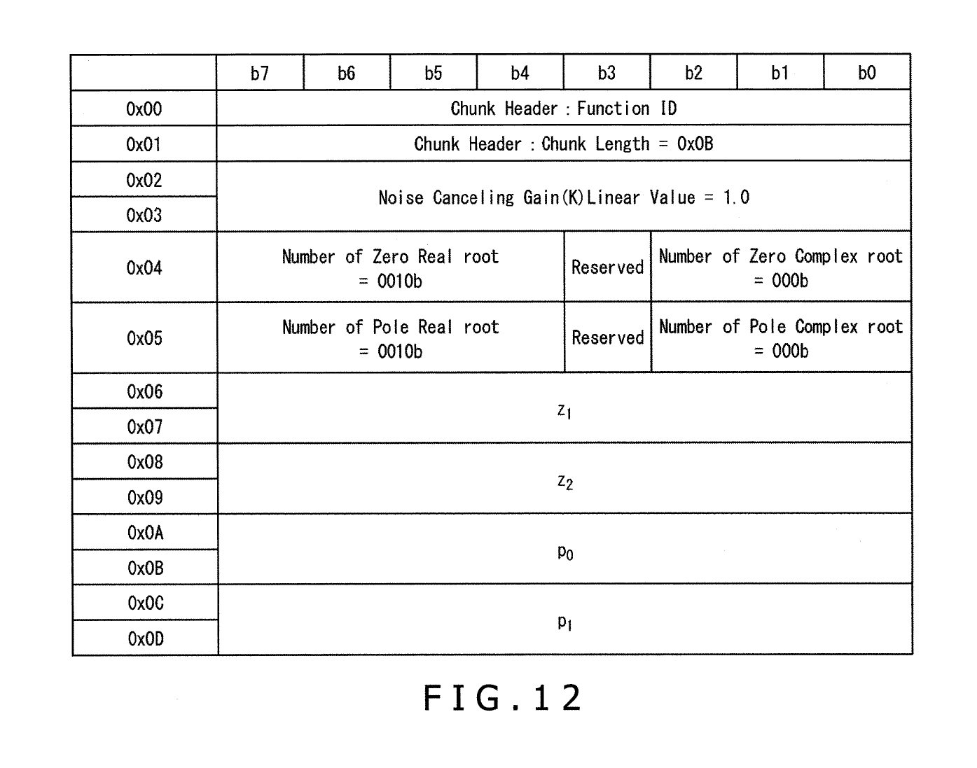

Assume now an intermediate parameter depicted in FIG. 12 as an intermediate parameter that is processed by the NC filter 801 depicted in FIG. 11. Obviously, the NC filter depicted in FIG. 11 cannot actually realize noise cancelation; this assumption is used for simply describing operations of an intermediate parameter and the translator 604 by way of example.

FIG. 12 depicts an example of an intermediate parameter. In the example depicted in FIG. 12, an eight-bit function ID is arranged at the beginning of a chunk header and an eight-bit chunk length is arranged in a next chunk header. In the following 8×2 bits, a value of noise canceling gain (K) is arranged. Further, four bits of the number of zero point real roots, three bits of the number of zero point complex roots, four bits of the number of pole real roots, and three bits of the number of pole complex roots are arranged. Subsequently, two zero points z₀ and z₁ and two poles p₀ and p₁ are arranged in 8×2 bits each.

In the example depicted in FIG. 12, the number of zero point real roots is two and the number of pole real roots is two, so that the transfer function can be expressed as follows.

$$\begin{matrix}[ Mathematical expression 2 ] & \\ \begin{matrix}F ( s ) = \frac{( s - {z}_{1} ) ( s - {z}_{2} )}{( s - {p}_{1} ) ( s - {p}_{2} )} \\ = \frac{{s}^{2} + ( - {z}_{1} - {z}_{2} ) s + {z}_{1} {z}_{2}}{{s}^{2} + ( - {p}_{1} - {p}_{2} ) s + {p}_{1} {p}_{2}} \\ = \frac{{A}_{0} {s}^{2} + {A}_{1} s + {A}_{2}}{{s}^{2} + {B}_{1} s + {B}_{2}}\end{matrix} & ( 5 )\end{matrix}$$

From the above-mentioned expression (5) and expression (6) that is the transfer function of the digital filter is generated.

$$\begin{matrix}[ Mathematical expression 3 ] & \\ F ( z ) = \frac{{a}_{0} + {a}_{1} {z}^{- 1} + {a}_{2} {z}^{- 2}}{1 + {b}_{1} {z}^{- 1} + {b}_{2} {z}^{- 2}} & ( 6 )\end{matrix}$$

The translator 604 execute z-transform such as bilinear transform of expression (5) (expression (7)) and so on by use of sampling frequency fₛ of the known noise canceling core 608 so as to deform the expression, thereby obtaining the coefficients (gains) a₀, a₁, a₂, b₁, and b₂ of expression (6).

$$\begin{matrix}[ Mathematical expression 4 ] & \\ s = \frac{2}{T} \frac{1 - {z}^{- 1}}{1 + {z}^{- 1}} = α \frac{1 - {z}^{- 1}}{1 + {z}^{- 1}} & ( 7 ) \\ {a}_{0} = \frac{{A}_{0} {α}^{2} + {A}_{1} α + {A}_{2}}{{α}^{2} + {B}_{1} α + {B}_{2}} & ( 8 ) \\ {a}_{1} = \frac{- 2 {A}_{0} {α}^{2} + 2 {A}_{2}}{{α}^{2} + {B}_{1} α + {B}_{2}} & ( 9 ) \\ {a}_{2} = \frac{{A}_{0} {α}^{2} - {A}_{1} α + {A}_{2}}{{α}^{2} + {B}_{1} α + {B}_{2}} & ( 10 ) \\ {b}_{1} = \frac{- 2 {α}^{2} + 2 {B}_{2}}{{α}^{2} + {B}_{1} α + {B}_{2}} & ( 11 ) \\ {b}_{2} = \frac{{α}^{2} - {B}_{1} α + {B}_{2}}{{α}^{2} + {B}_{1} α + {B}_{2}} & ( 12 )\end{matrix}$$

A desired noise canceling filter characteristic can be obtained by multiplying transfer function F(z) of the digital filter obtained as above by the noise canceling gain (K).

Actually, the noise canceling core 608 has of course an NC filter configuration different from that depicted in FIG. 11, so that it is necessary to build in a native parameter computation method different from that described above into the translator 604 in accordance with the specifications of the noise canceling core 608.

So far, a method of transforming an intermediate parameter into a native parameter suitable for the noise canceling core 608 by the translator 604 has been described. The following describes a method of creating an intermediate parameter.

For the description, an example of one quadratic biquad IIR filter is used. The transfer function of this filter is expressed by the following expression. This expression (13) is the same as expression (5).

$$\begin{matrix}[ Mathematical expression 5 ] & \\ F ( s ) = \frac{{A}_{0} {s}^{2} + {A}_{1} s + {A}_{2}}{{s}^{2} + {B}_{1} s + {B}_{2}} & ( 13 )\end{matrix}$$

From the transfer function of expression (13), the following zero point z and pole p are obtained.

$$\begin{matrix}[ Mathematical expression 6 ] & \\ z = \frac{- {A}_{1} \pm \sqrt{{A}_{1}^{2} - 4 {A}_{0} {A}_{2}}}{2 {A}_{0}} & ( 14 ) \\ p = \frac{- {B}_{1} \pm \sqrt{{B}_{1}^{2} - 4 {B}_{2}}}{2} & ( 15 )\end{matrix}$$

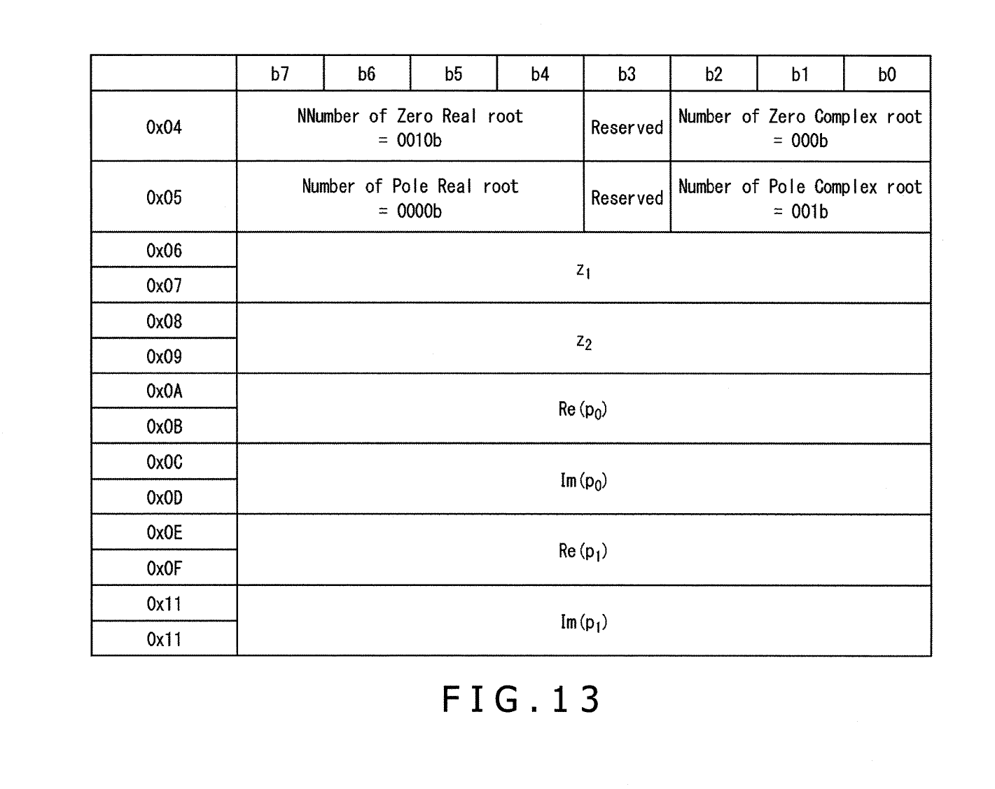

Both the zero point and the pole can be complex roots. When they are complex roots, they become complex conjugates. For example, if the number of real roots is two for zero point and the number of complex roots is two for pole, the intermediate parameter is stored in the nonvolatile memory 585 of the headphone 520 as depicted in FIG. 13.

FIG. 13 is a diagram illustrating an example of writing an intermediate parameter. Since the real roots are stored in the nonvolatile memory 585 without change, the number of real roots are also stored in the nonvolatile memory 585 without change. In the example depicted in FIG. 13, the number of zero point real roots and the number of pole real roots are stored in four bits each. In the case of a complex root, it becomes a complex conjugate, so that only the positive imaginary number components are stored in the nonvolatile memory 585. Therefore, the number of complex roots is stored in the nonvolatile memory 585 in a value that is half of the actual number of roots.

In the example depicted in FIG. 13, the number of zero point complex roots and the number of pole complex roots are stored in three bits each. In addition, the real number parts Re(p₀), Re(p₁) and the imaginary number parts Im(p₀), Im(p₁) of two zero points z₁, z₂ and two poles p_{c}, p₁ are arranged. If there is any complex root in the intermediate parameter, the translator 604 executes processing by developing the complex root into a complex conjugate.

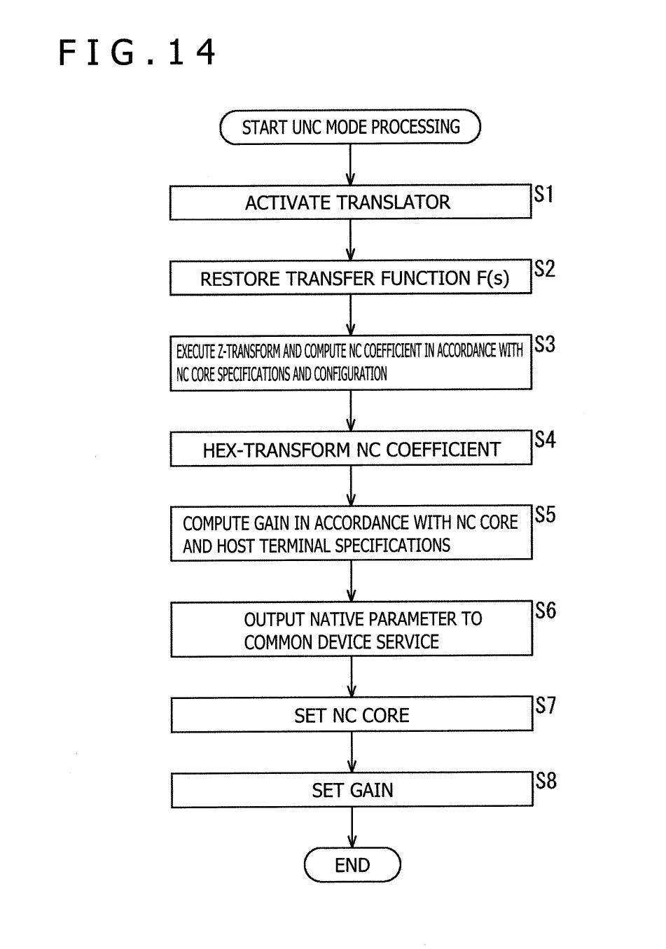

When the zero point and the pole have been acquired, then the translator 604 restores the transfer function on the s-plane like the expression (5) described above, for example, and executes z-transform with the expression (7), thereby obtaining a transfer function (expression (6)) and a coefficient (expression (8) through expression (12)) of the digital filter. The coefficient is transformed by following a coefficient format of the noise canceling core 608. For example, the 24 bits of coefficient bit length are transformed as (3, 21). The “3” of (3, 21) indicates the number of integer bits and the “21” indicates the number of decimal bits. After the transform, a resultant value is set to the noise canceling core 608. Further, the following describes the processing of the UNC mode in the host terminal 510 and the headphone 520 depicted in FIG. 10 by use of a flowchart. FIG. 14 depicts a flowchart for describing the processing of the UNC mode.

In step S1, the manager 603 of the host terminal 510 activates the translator 604. At this moment, on the basis of an instruction from the host terminal 510, an intermediate parameter stored in the nonvolatile memory 585 of the headphone 520 is read therefrom to be supplied to the transmission/reception processing block 547 of the host terminal 510 by multiplexed data communication through the transmission processing block 578. The intermediate parameter supplied to the transmission/reception processing block 547 is further supplied to the translator 604 through the driver 605, the manager 603, and the common device service 602.

In step S2, the translator 604 restores the transfer function F(s) (expression (4)). In step S3, the translator 604 executes z-transform in accordance with the specifications and configuration of the noise canceling core 608 so as to compute a coefficient (NC coefficient) for noise cancelation (expression (7) through expression (12)). In other words, a native parameter is computed.

In step S4, the translator 604 transforms the coefficient for noise cancelation computed in step S3 into a hexadecimal number (HEX). Further, in step S5, the translator 604 computes a gain (noise canceling gain (K)) in accordance with the specifications of the noise canceling core 608. This is also a native parameter.

In step S6, the translator 604 outputs the native parameter computed by the processing in steps S5 and S6 to the common device service 602. In step S7, the common device service 602 sets the noise canceling core 608. Specifically, the noise canceling coefficient obtained by the processing in steps S3 and S4 is set to the noise canceling core 608 through the driver 605. Further, in step S8, the device service 607 sets the gain. Specifically, the noise canceling gain (K) is set to the noise canceling core 608 through the driver 605, thereby setting the gain of the headphone amplifier (power amplifier 532).

<7. Processing of a Headphone>

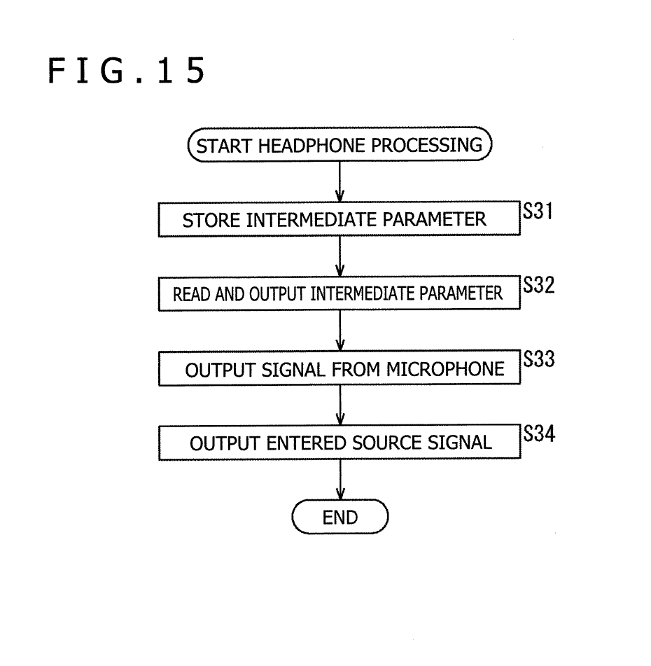

The following describes the processing of the headphone 520 to be executed when the UNC mode is set. FIG. 15 is a flowchart indicative of an operation of the headphone.

In step S31, the nonvolatile memory 585 stores the intermediate parameter. This processing is executed before the user purchases the headphone 520. In step S32, the transmission processing block 578 reads and outputs the intermediate parameter. Specifically, on the basis of an instruction from the host terminal 510, the intermediate parameter stored in the nonvolatile memory 585 is read. Then, as described above, on the basis of this intermediate parameter, the setting of the noise canceling core 608 and the headphone amplifier 532 of the host terminal 510 are executed.

In step S33, the headphone 520 outputs a signal from a microphone 581 (581₀, 581₁, 581₂, 581₃, and 581₄). That is, a microphone signal (audio signal) corresponding to a sound picked up by the microphone 581 of the headphone 520 is supplied from the transmission processing block 578 to the host terminal 510 by multiplex data communication. The transmission/reception processing block 547 of the host terminal 510 outputs the received microphone signal to the noise canceling core 608 to which the parameter is set.

In addition, in step S34, the driver 561 (561L and 561R) of the headphone 520 outputs a source signal entered from the host terminal 510. That is, as described above with reference to FIG. 2, a noise canceling signal is added to a source signal to be supplied to the driver 561 (561L and 561R) of the headphone 520 through the headphone amplifier (HP AMP). The driver 561 outputs a sound corresponding to the signal received from the host terminal 510. This sound is synthesized with the noise sound directed entered in the ears of the user, thereby executing noise cancelation processing.

It is very bothersome for user to check whether or not a product intended to be purchased can realize a target function when it is connected to a device owned by the user (whether or not the product intended to be purchased is compatible with a device owned by the user). The user is hard to dispel these concerns. For example, this holds true with a noise canceling headphone of circuit-separated type described so far that includes the multiplexed data communication function and holds parameters unique to the model of that noise canceling headphone.

The present technology eliminates the necessity for the user to check the own device for the compatibility as described above, namely, the user is required only to check the compatibility with UNC, thereby giving a sense of reassurance and promoting the desire for purchase.

This holds true with vendors that develop accessory devices. In the case of an accessory device having only the function of SNC, in the past, it is necessary to create native parameters that match the specifications of each host terminal and each noise canceling core. Hence, in order to increase the number of compatible models, the knowledge of each of host terminal and signal processing computation block hardware is required, at the same time, it takes time and labor to create the native parameters. As a result, although it is technically possible to be compatible with all host terminals, but it is practically difficult.

The present technology allows vendors of accessory devices to realize the noise canceling function in combinations of all host terminals installed the noise canceling function compatible with UNC in the case of headphones, for example by storing intermediate parameters in each accessory device. Regardless of the vendor of a particular host terminal or the vendor of a particular noise canceling core to be installed on a host terminal, compatibility is promised, thereby providing opportunities of purchase by more users.

<8. Processing of Mode Selection>

It is possible for the host terminal 510 and the headphone 520 to have only one of the SNC mode and the UNC mode. However, in this case, ease of use for users is deteriorated.

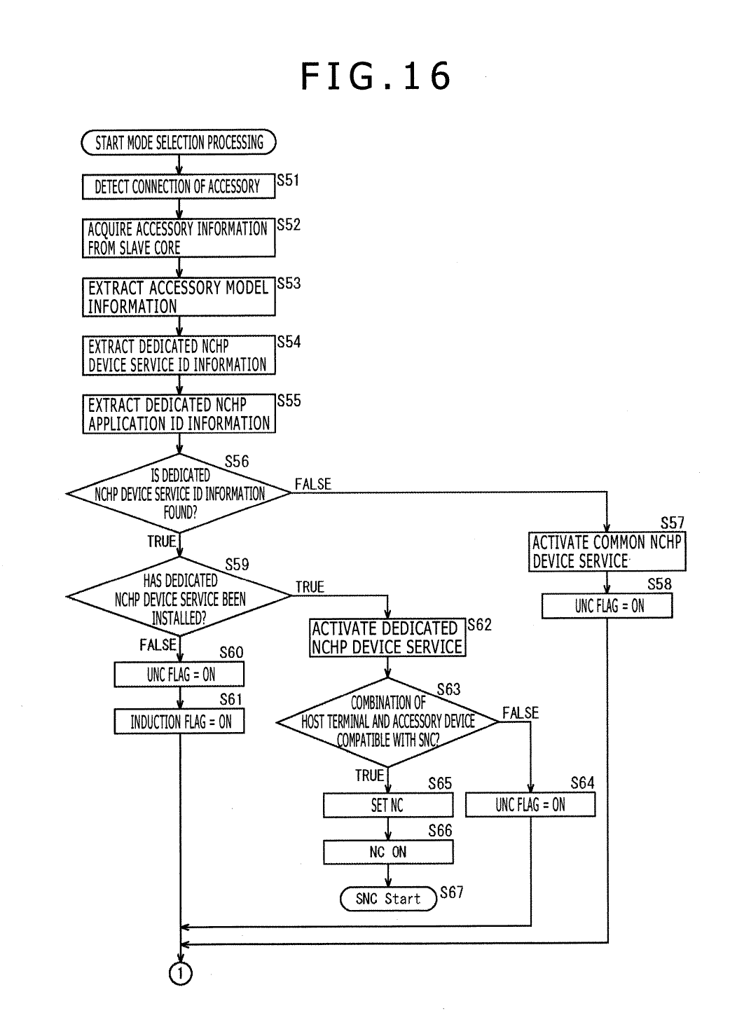

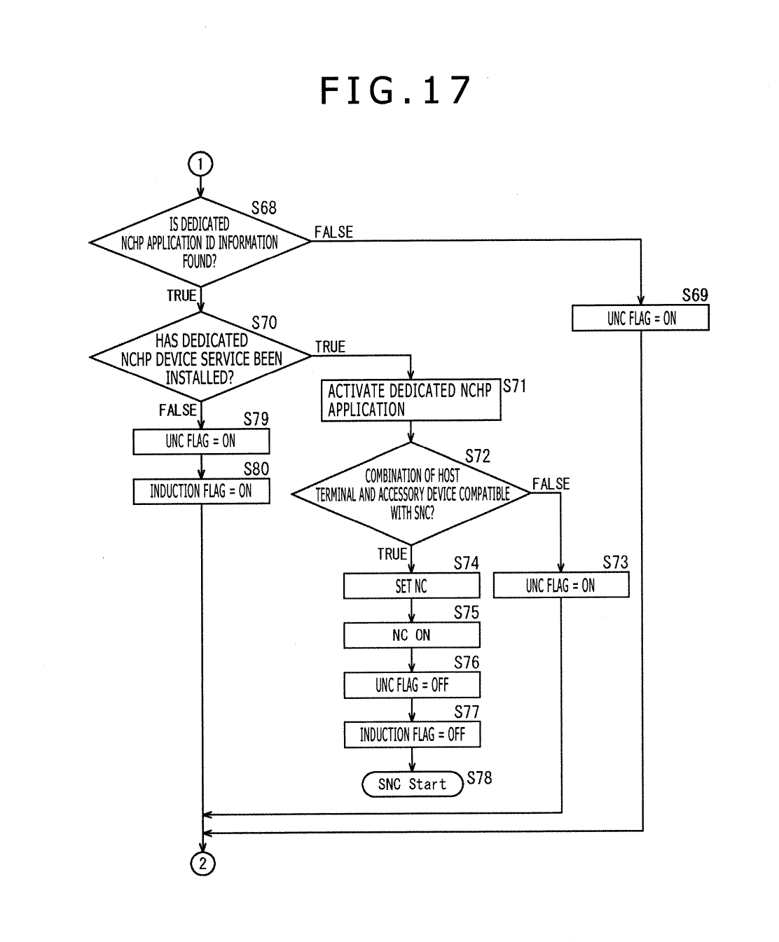

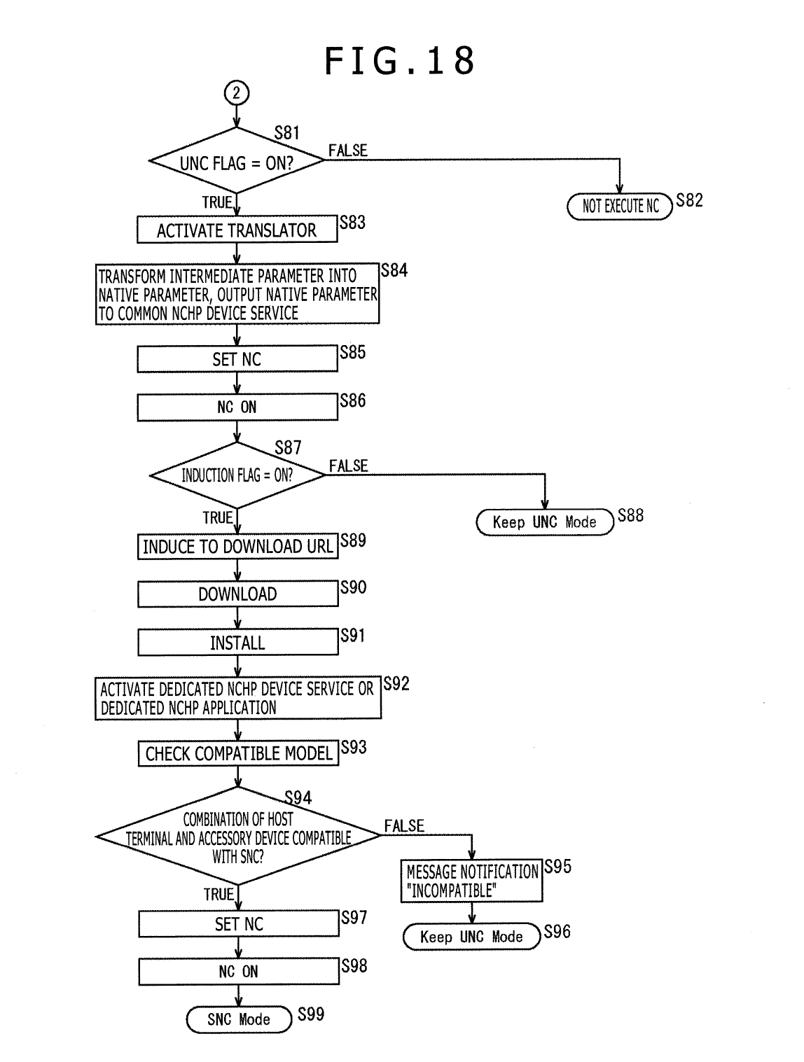

Therefore, it is desired to use the host terminal 510 and the headphone 520 in both the SNC and UNC modes. For example, FIG. 5 depicts an example of the headphone 211A, the host terminals 212A and 212B and FIG. 6 depicts an example of the headphones 211E and 211F and the host terminal 212E. Specifically, both intermediate parameters and the native parameters (or the information necessary for accessing and acquiring these parameters) are stored in the nonvolatile memory 585 of the headphone 520 and the nonvolatile memories 221A, 221E, and 221F of the headphones 211A, 211E, and 211F. In this case, it is more convenient if one of the modes can be preferentially set over the other in an automatic manner. The following describes this processing with reference to FIG. 16 through FIG. 18.

FIG. 16 through FIG. 18 depict the flowcharts for describing the mode selection processing. In step S51, the host terminal 510 detects accessory connection. Specifically, the connection of the headphone 520 is detected. Specifically, as described above, this detection is executed by detecting of the connection of the microphone 581 by the microphone detection block 544.

In step S52, the manager 603 of the host terminal 510 acquires accessory information from a slave core. That is, a request is issued from the host terminal 510 to the headphone 520 as an accessory device for reading product information as accessory information from the nonvolatile memory 585 of the headphone 520. For example, a model name, an intermediate parameter, SNC application information, and so on are read. In step S53, the manager 603 extracts accessory model information. That is, the accessory model information is extracted from the accessory information acquired by the processing in step S52.

In step S54, the manager 603 extracts dedicated NCHP device service ID information. The dedicated NCHP device service is the dedicated NCHP device service 607 that processes (or realizes SNC) a dedicated native parameter for the combination of the particular headphone 520 and host terminal 510. This processing allows the extraction of the ID information of the dedicated NCHP device service 607 as the dedicated NCHP device service ID information from the accessory information acquired by the processing in step S52.

In step S55, the manager 603 extracts dedicated NCHP application ID information. The dedicated NCHP application is a dedicated NCHP application 606 for processing (or realizing SNC) the dedicated native parameter for the combination of the particular headphone 520 and host terminal 510. It should be noted that the dedicated NCHP application 606 is an application for the noise canceling head phone (NCHP), so that it is indicated as an NCHP application. The dedicated NCHP application 606 is indicated also simply as the dedicated application 606 as required. The processing allows the extraction of the ID information of the dedicated NCHP application 606 as the dedicated NCHP application ID information from the accessory information acquired by the processing in step S52.

The type and installation of the dedicated NCHP device service and the dedicated NCHP application can be decided from the dedicated NCHP device service ID information and the dedicated NCHP application ID information.

In step S56, the manager 603 decides whether or not the dedicated NCHP device service ID information is found. Specifically, in step S54, the manager 603 decides whether or not the extraction of the dedicated NCHP device service ID information is found.

If the dedicated NCHP device service ID information is not found in step S56, the processing goes to step S57. In step S57, the manager 603 activates the common NCHP device service 602. In step S58, the manager 603 turns on a UNC flag. When the UNC flag is turned on, the UNC mode is set in steps S81, S83, S84, S85, and S86 to be described later unless the SNC mode is subsequently set.

On the other hand, if the dedicated NCHP device service ID information is found in step S56, in step S59, the manager 603 decides whether or not the dedicated NCHP device service has already been installed. If the dedicated NCHP device service is already installed, in step S62, the manager 603 activates the dedicated NCHP device service 607.

In step S63, the dedicated NCHP device service 607 decides whether or not the combination of host terminal and accessory device is compatible with SNC. If the current host terminal 510 and headphone 520 are not in a combination compatible with SNC, SNC cannot be used. Therefore, in step S64, the manager 603 turns on the UNC flag. When the UNC flag is turned on, the UNC mode is set in steps S81, S83, S84, S85, and S86 to be described later unless the SNC mode is subsequently set.

In step S63, it is decided that the host terminal 510 and the headphone 520 are in a combination compatible with SNC, in step S65, the dedicated NCHP device service 607 sets noise cancelation. That is, a native parameter is set to the noise canceling core 608. In step S66, the dedicated NCHP device service 607 turns on noise cancelation. Then, in step S67, the noise cancelation processing using the native parameter, namely, SNC is started.

In step S59, it is decided that the dedicated NCHP device service ID information is found, but the dedicated NCHP device service is found to be not yet installed, the manager 603 turns on the UNC flag in step S60. When the UNC flag is turned on, then the UNC mode is set in steps S81, S83, S84, S85, and S86 to be described later unless the SNC mode is subsequently set. Further, in step S61, the manager 603 turns on an induction flag. Consequently, the installation of the common NCHP device service by the user is induced by the processing in steps S87, S89, and subsequent steps.

After the processing in steps S58, S61, and S64, the manager 603 decides in step S68 whether or not the dedicated NCHP application ID information is found. If the dedicated NCHP application ID information is not found, which means, the dedicated NCHP application ID information cannot be extracted by the processing in step S55, the manager 603 turns on the UNC flag in step S69. Once the UNC flag is turned on, subsequently, the UNC mode is set in steps S81, S83, S84, S85, and S86 to be described later unless the SNC mode is set.

On the other hand, if the dedicated NCHP application ID information is found in step S68, the manager 603 decides in step S70 whether or not the dedicated NCHP application has already been installed. If the dedicated NCHP application is already installed, the manager 603 activates the dedicated NCHP application 606 in step S71.

In step S72, the dedicated NCHP application 606 decides whether or not the combination of host terminal and accessory device is compatible with SNC. If the current host terminal 510 and headphone 520 are not in a combination compatible with SNC, SNC cannot be used. Therefore, in step S73, the manager 603 turns on the UNC flag. When the UNC flag is turned on, the UNC mode is set in steps S81, S83, S84, S85, and S86 to be described later unless the SNC mode is subsequently set.

In step S72, it is decided that the host terminal 510 and the headphone 520 are in a combination compatible with SNC, in step S74, the dedicated NCHP application 606 sets noise cancelation. That is, a native parameter is set to the noise canceling core 608. In step S75, the dedicated NCHP application 606 turns on noise cancelation. In other words, SNC is executed.

In this case, SNC is to be executed, so that the manager 603 turns off the UNC flag in step S76. In addition, the manager 603 turns off the induction flag in step S77. Next, in step S78, the noise cancelation processing by use of the native parameter, namely, SNC is started.

In step S70, it is decided that the dedicated NCHP application is found to be not yet installed, the manager 603 turns on the UNC flag in step S79. Once the UNC flag is turned on, the UNC mode is set in steps S81, S83, S85, and S86 to be described later unless the SNC mode is subsequently set. Further, in step S80, the manager 603 turns on the induction flag. Consequently, the installation of the common NCHP device service by the user is induced by the processing in step S87, S89, and subsequent steps as will be described later. In other words, the same processing operations as those in steps S60 and S61 are executed.

After the processing operations in steps S69, S73, and S80, the common NCHP device service 602 decides whether or not the UNC flag is on in step S81. The case in which the UNC flag is found not to be on (found to be off) indicates the case in which the SNC processing are already executed by the processing operations in steps S65, S66, and S67 or steps S74, S75, S76, S77, and S78. Therefore, if the UNC flag is found not to be on (found to be off), noise cancelation processing is not executed in step S82.

It is decided that the UNC flag is found to be on in step S81, the processing goes to step S83. The case in which the UNC flag is found to be on denotes the case in which the dedicated NCHP device service ID information does not exist (decision is “false” in step S56) or the dedicated NCHP device service is not installed (decision is “false” in step S59). This denotes also the case in which the dedicated NCHP application ID information does not exist (decision is “false” in step S68) or the dedicated NCHP application is not installed (decision is “false” in step S70). In other words, the SNC mode is not executed in step S67 or step S78.

If the UNC flag is found to be on in step S81, in step S603, the manager 603 activates the translator 604. In step S84, the translator 604 transforms the intermediate parameter into a native parameter having a format compliant with the specifications of the noise canceling core 608 and outputs the resultant native parameter to the common NCHP device service 602. In step S85, the common NCHP device service 602 sets the noise cancelation processing. That is, the native parameter is set to the noise canceling core 608. In step S86, the common NCHP device service 602 turns on the noise cancelation processing. In other words, UNC is executed.

In step S87, the manager 603 decides whether or not the induction flag is on. If the dedicated NCHP device service is not installed despite of the existence of the dedicated NCHP device service ID information, the induction flag is turned on in step S51. Likewise, if the dedicated NCHP application is not installed despite of the existence of the dedicated NCHP application ID information, the induction flag is turned on in step S80.

It is decided that the induction flag is found not to be on (found to be off), the UNC mode is maintained in steps S88. That is, the UNC set by the processing operations in steps S83, S84, S85, and S86 is maintained without change.

If the induction flag is to be on in step S87, the processing goes to step S89. In this case, the dedicated NCHP device service is not installed despite of the existence of the dedicated NCHP device service ID information and the dedicated NCHP application is not installed despite of the existence of the dedicated NCHP application ID information.

In step S89, the common NCHP device service 602 induces the user to download URL. Specifically, the common NCHP device service 602 executes predetermined display for making the user access a download site, for example, thereby prompting the user to access the URL and download the dedicated NCHP device service or the dedicated NCHP application.

When the user gives an instruction for downloading, in step S90, the downloading is executed to install the downloaded service or application in step S91.

In step S92, the manager 603 activates the dedicated NCHP device service 607 or the dedicated NCHP application 606. Specifically, the installed dedicated NCHP device service 607 or the installed dedicated NCHP application 606 is activated. In step S93, the dedicated NCHP device service 607 or the dedicated NCHP application 606 checks a compatible model.

In step S94, the dedicated NCHP device service 607 or the dedicated NCHP application 606 decides whether or not the combination of host apparatus and accessory device is compatible with SNC. If the current host terminal 510 and the current headphone headphone 520 are not of a combination compatible with SNC, SNC cannot be used. Therefore, in step S95, the manager 603 notifies a message. Specifically, the manager 603 notifies the user of SNC non-compatibility. Then, in step S96, the UNC mode is maintained. That is, the UCN set by the processing operations in steps S83, S84, S85, and S86 is maintained without change.

In step S94, it is decided that the host terminal 510 and the headphone 520 are in a combination compatible with SNC, in step S97, the dedicated NCHP device service 607 or the dedicated NCHP application 606 sets the noise canceling core 608. That is, the setting based on the native parameter is executed. In step S98, the dedicated NCHP device service 607 or the dedicated NCHP application 606 turns on noise cancelation. Then, in step S99, the SNC mode is set.

As described above, in the mode selection processing depicted in FIG. 16 through FIG. 18, if the dedicated NCHP device service 607 or the dedicated NCHP application 606 has already been installed, the SNC mode is preferentially set over the UNC mode. Since the native parameter prepared in a dedicated manner is used, more effective noise cancelation processing is promised in the SNC mode rather than the UNC mode. Therefore, the automatic setting of the SNC mode allows the user to listen the sound of high quality more quickly.

Obviously, the UNC mode can be prioritized, conversely. For example, activation first in the UNC mode at the time of initial connection allows the provision of the noise cancelation effect until the dedicated NCHP device service or the dedicated NCHP application is installed.

It is also practicable to let the user select the priority between the UNC mode and the SNC mode. That is, the mode selected by the user may be preferentially set. The user can prioritize the UNC mode, for example so as to try the noise cancelation effects in the UNC mode under a predetermined environment. Further, the user is permitted to set any one of the UNC mode and the SNC mode.

The automatic switching based on the present technology between UNC for realizing mutual connection compatibility and SNC for providing high performance due to particular combinations allows the user to experience the effects of noise cancelation as quick as possible.

<9. Variations>

It should be noted that the transfer of intermediate parameters between accessory device and a host terminal is not limited to multiplexed data communication and does not require wired communication or wireless communication.

In addition, the present technology is also applicable to equalizers, hearing aids, monitors for music and others. For example, the present technology can realize a form in which the intermediate parameters of an equalizer and a monitor are held in an accessory device and the translators of the equalizer and the monitor are installed on the host terminal. As far as common intermediate parameters are defined under a certain standard, the content of the function is not inquired. Hence, between various types of accessory devices and host terminals, the present technology can realize the mutual connection compatibility of subject functions, widen the width of user's product purchase selection, providing vendors with many compatible devices, and widen the target users.

In addition, the present technology is applicable to a portable music player (for example, Walkman (registered trademark)), a mobile game machine (for example, Playstation Vita (registered trademark)), a game machine controller (for example, Play Station 4 (registered trademark)), and so on. Specifically, the present technology is applicable to various types of information processing apparatuses to which headphone are connected.

A network denotes a scheme in which at least two apparatuses are connected and information is transmitted from one apparatus to another. Apparatuses for communicating each other through a network may be independent of each other or internal blocks that constitute one apparatus.

Further, needless to say, communication may be wireless communication or wired communication, or the mixture of them. Specifically, wireless communication may be executed in a certain section, while wired communication may be executed in another section. Still further, communication may be executed from a certain apparatus to another apparatus with wired manner, and communication may be executed from another apparatus to a certain apparatus with wireless manner.

In the present specification, a system denotes a set of two or more components (apparatuses, modules (parts), and the like). It does not matter whether all components are accommodated in one housing. Therefore, accommodated in separate housings, two or more apparatuses connected through a network and one apparatus with two or more modules accommodated in one housing, both constitute a system.

It should be noted that the embodiments of the present technology are not limited to that described above. Various changes to the present technology are practicable unless such changes get out of the spirit of the present technology.

For example, the present technology can take a configuration of cloud computing in which one function is processed in a divided and shared manner by two or more apparatuses through a network.

Further, each of the steps described with reference to the flowcharts mentioned above may be executed by one apparatus or two or more apparatuses in a divided manner.

In addition, if two or more processing operations are included in one step, these two or more processing operations can be executed by one apparatus or by two or more apparatuses in a divided manner.

The series of processing operations described above may be executed by hardware or software. If the series of processing operations are executed by software, a program configuring that software is installed on a computer. Here, computers include a computer in which dedicated hardware is built in and a general-purpose personal computer, for example that can execute various functions by installing various programs.

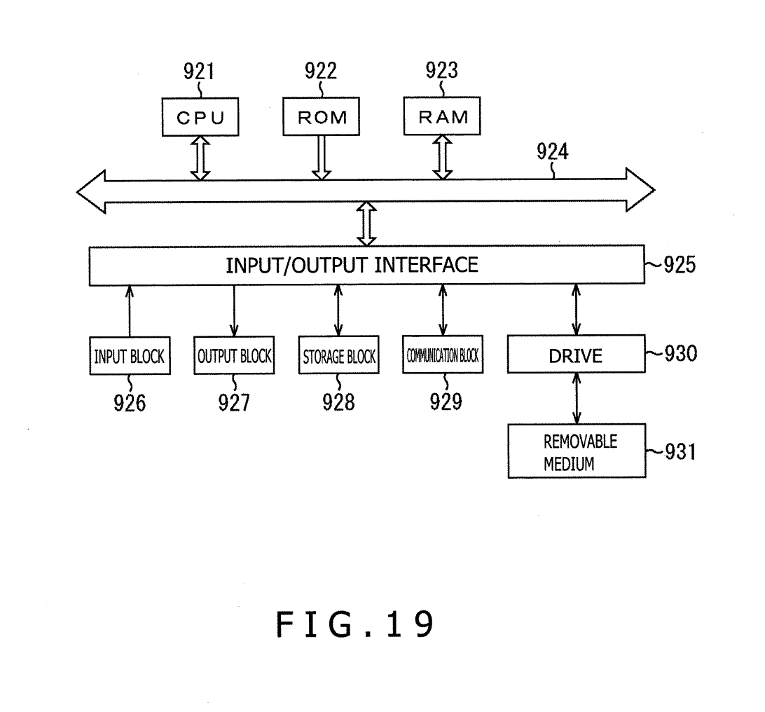

Now, referring to FIG. 19, there is depicted a block diagram illustrating an example of a configuration of computer hardware that executes the above-mentioned series of processing operations by programs.

In a computer, a central processing unit (CPU) 921, a read only memory (ROM) 922, and a random access memory (RAM) are connected with a bus 924.

The bus 924 is further connected with an input/output interface 925. The input/output interface 925 is connected with an input block 926, an output block 927, a storage block 928, a communication block 929, and a drive 210.

The input block 926 is made up of a keyboard, a mouse, a microphone, and so on. The output block 927 is made up of a display, a speaker, and so on. The storage block 928 is made up of hard disk drive, a nonvolatile memory, or the like. The communication block 928 is made up of a network interface or the like. The drive 930 drives a removable medium 931 such as a magnetic disc, an optical disc, a magneto-optical disc, or a semiconductor memory.

In the computer configured as described above, the CPU 921 loads a program stored in the storage block 928, for example, through the input/output interface 925 and the bus 924 into the RAM 923 and executes the loaded program, thereby executing the above-mentioned series of processing operations.

In the computer, the programs can be installed in the storage block 928 through the input/output interface 925 by mounting a removable media 931 on the drive 930 as a package media, for example. Further, programs can be received by the communication block 929 through wired or wireless transmission medium so as to be installed in the storage block 928. In addition, programs can be installed in the ROM 922 or storage block 928 in advance.

It should be noted that each program to be executed by a computer may be a program by which processing operations are executed in time series along a sequence described in the present specification or executed in parallel or executed on an on-demand basis.

<10. Others>

The present technology can take the following configuration.

(1)

An information processing apparatus including:

a generation block configured, upon receiving an intermediate parameter having a format common to a plurality of information processing apparatuses, the intermediate parameter being a parameter unique to a predetermined device from the predetermined device, to generate an adjustment parameter suitable for an own information processing apparatus from the intermediate parameter; and

a signal computation block configured to compute a signal on the basis of the adjustment parameter generated by the generation block.

(2)

The information processing apparatus according to (1) above, wherein

the information processing apparatus is a host terminal connected to an accessory device that is the device.

(3)

The information processing apparatus according to (1) or (2) above, wherein

the intermediate parameter includes a parameter related with a transfer function of a signal computation block that computes a signal on the basis of the adjustment parameter of the information processing apparatus and a parameter related with a physical characteristic of the accessory device.

(4)

The information processing apparatus according to (1), (2), or (3) above, wherein

the information processing apparatus receives one of the intermediate parameter held in the device and the intermediate parameter on the basis of information necessary for accessing the intermediate parameter.

(5)

The information processing apparatus according to (1) through (4) above, wherein

the information processing apparatus further receives an environment signal indicative of an environment state computed on the basis of the adjustment parameter.

(6)

The information processing apparatus according to (1) through (5) above, wherein

the information processing apparatus receives the environment signal that mitigates an influence of the environment state on the basis of the adjustment parameter.

(7)

The information processing apparatus according to (1) through (6) above, wherein

the accessory device executes multiplexed data communication with the host terminal through a multi-pole plug.

(8)

An information processing method for an information processing apparatus, including:

generating, upon receiving an intermediate parameter having a format common to a plurality of information processing apparatuses, the intermediate parameter being a parameter unique to a predetermined device from the predetermined device, an adjustment parameter suitable for the own information processing apparatus from the intermediate parameter; and

computing a signal on the basis of the generated adjustment parameter.

(9)

An information processing apparatus including:
a parameter supply block configured to supply an intermediate parameter having a format common to a plurality of devices to the device, the intermediate parameter being unique to an own information processing apparatus; and

a reception block configured to receive, from the device, a computation signal computed on the basis of adjustment parameter suitable for the device generated from the intermediate parameter in the device.

(10)

The information processing apparatus according to (9) above, wherein

the information processing apparatus is an accessory device connected to a host terminal that is the device.

(11)

The information processing apparatus according to (9) or (10) above, wherein

the intermediate parameter includes a parameter related with a transfer function of a signal computation block that computes a signal on the basis of the adjustment parameter of the device and a parameter related with a physical characteristic of the accessory device.

(12)

The information processing apparatus according to (9), (10), or (11) above, wherein

the parameter supply block supplies one of the intermediate parameter held therein and information necessary for accessing the intermediate parameter.

(13)

The information processing apparatus according to (9) through (12) above, further including:

an environment signal supply block configured to supply, to the device, an environment signal indicative of an environment state computed on the basis of the adjustment parameter.

(14)

The information processing apparatus according to (9) through (13) above, wherein

the environment supply block supplies the environment signal that mitigates an influence of the environment state on the basis of the adjustment parameter.

(15)

The information processing apparatus according to (9) through (14) above, wherein

the accessory device executes multiplexed data communication with the host terminal through a multi-pole plug.

(16)

An information processing method for an information processing apparatus, including:

supplying an intermediate parameter having a format common to a plurality of devices to the device, the intermediate parameter being unique to an own information processing apparatus; and

receiving, from the device, a computation signal computed on the basis of adjustment parameter suitable for the device generated from the intermediate parameter in the device.

### REFERENCE SIGNS LIST

51 . . . Information processing apparatus, 61 . . . Headphone, 62 . . . Host terminal, 201 . . . Noise canceling system, 211 . . . Headphone, 212 . . . Host terminal, 221 . . . Nonvolatile memory, 222, 231 . . . Multiplexed data interface, 232 . . . Translator, 233 . . . Noise canceling core

1. An information processing apparatus comprising:
a generation block configured, upon receiving an intermediate parameter having a format common to a plurality of information processing apparatuses, the intermediate parameter being a parameter unique to a predetermined device from the predetermined device, to generate an adjustment parameter suitable for an own information processing apparatus from the intermediate parameter; and
a signal computation block configured to compute a signal on the basis of the adjustment parameter generated by the generation block.

2. The information processing apparatus according to claim 1, wherein
the information processing apparatus is a host terminal connected to an accessory device that is the device.

3. The information processing apparatus according to claim 2, wherein
the intermediate parameter includes a parameter related with a transfer function of a signal computation block that computes a signal on the basis of the adjustment parameter of the information processing apparatus and a parameter related with a physical characteristic of the accessory device.

4. The information processing apparatus according to claim 3, wherein
the information processing apparatus receives one of the intermediate parameter held in the device and the intermediate parameter on the basis of information necessary for accessing the intermediate parameter.

5. The information processing apparatus according to claim 4, wherein
the information processing apparatus further receives an environment signal indicative of an environment state computed on the basis of the adjustment parameter.

6. The information processing apparatus according to claim 5, wherein
the information processing apparatus receives the environment signal that mitigates an influence of the environment state on the basis of the adjustment parameter.

7. The information processing apparatus according to claim 6, wherein
the accessory device executes multiplexed data communication with the host terminal through a multi-pole plug.

8. An information processing method for an information processing apparatus, comprising:
generating, upon receiving an intermediate parameter having a format common to a plurality of information processing apparatuses, the intermediate parameter being a parameter unique to a predetermined device from the predetermined device, an adjustment parameter suitable for the own information processing apparatus from the intermediate parameter; and
computing a signal on the basis of the generated adjustment parameter.

9. An information processing apparatus comprising:
a parameter supply block configured to supply an intermediate parameter having a format common to a plurality of devices to the device, the intermediate parameter being unique to an own information processing apparatus; and
a reception block configured to receive, from the device, a computation signal computed on the basis of adjustment parameter suitable for the device generated from the intermediate parameter in the device.

10. The information processing apparatus according to claim 9, wherein
the information processing apparatus is an accessory device connected to a host terminal that is the device.

11. The information processing apparatus according to claim 10, wherein
the intermediate parameter includes a parameter related with a transfer function of a signal computation block that computes a signal on the basis of the adjustment parameter of the device and a parameter related with a physical characteristic of the accessory device.

12. The information processing apparatus according to claim 11, wherein
the parameter supply block supplies one of the intermediate parameter held therein and information necessary for accessing the intermediate parameter.

13. The information processing apparatus according to claim 12, further comprising:
an environment signal supply block configured to supply, to the device, an environment signal indicative of an environment state computed on the basis of the adjustment parameter.

14. The information processing apparatus according to claim 13, wherein
the environment supply block supplies the environment signal that mitigates an influence of the environment state on the basis of the adjustment parameter.

15. The information processing apparatus according to claim 14, wherein
the accessory device executes multiplexed data communication with the host terminal through a multi-pole plug.

16. An information processing method for an information processing apparatus, comprising:
supplying an intermediate parameter having a format common to a plurality of devices to the device, the intermediate parameter being unique to an own information processing apparatus; and
receiving, from the device, a computation signal computed on the basis of adjustment parameter suitable for the device generated from the intermediate parameter in the device.
